(19) United States
(12) Patent Application Publication
(10) Pub. No.: US 2014/0006055 A1
(43) Pub. Date: Jan. 2, 2014

(54) Integrated Medical Evaluation and Record Keeping System

(71) Applicant: Iagnosis, Inc., McMurray, PA (US)

(72) Inventors: Mark Seraly, Venetia, PA (US); Larry Eakin, McMurray, PA (US); Scott Focer, Allison Park, PA (US); Martin Shelly, Pittsburgh, PA (US); Mark Lotter, Pittsburgh, PA (US); Melissa Kovach, Greensburg, PA (US); John Catlos, Wexford, PA (US); Phil Kossler, Carnegie, PA (US); Rob Brown, Pittsburgh, PA (US); Ben Ritter, Pittsburgh, PA (US); Donald Lee Steward, Oakdale, PA (US); Ed Digregory, Pittsburgh, PA (US); James Hanlon, South Park, PA (US)

(21) Appl. No.: 13/927,888

(22) Filed: Jun. 26, 2013

Related U.S. Application Data
(60) Provisional application No. 61/665,051, filed on Jun. 27, 2012.
(60) Provisional application No. 61/781,554, filed on Mar. 14, 2013.

(51) Int. Cl. G06F 19/00; G06Q 50/24

(52) U.S. Cl. CPC G06F 19/322; G06Q 50/24
USPC 705/3

(57) ABSTRACT

A machine-based system for managing a medical evaluation is provided that includes a memory that has stored a first image taken by a user. A provider views the first image to conduct a medical evaluation. A processor is communicatively coupled to the memory and sends a request to the user to provide a second image for purposes of further conducting the medical evaluation after viewing of the first image by the provider. In some arrangements, the memory may store a condition history.

### CROSS REFERENCE TO RELATED APPLICATION

This application claims the benefit of U.S. Application Ser. No. 61/665,051 filed on Jun. 27, 2012 and entitled, “Integrated Medical Evaluation and Record Keeping System.” U.S. Application Ser. No. 61/665,051 is incorporated by reference herein in its entirety for all purposes. This application also claims the benefit of U.S. Application Ser. No. 61/781,554 filed on Mar. 14, 2013 and entitled, “Integrated Medical Evaluation and Record Keeping System.” U.S. Application Ser. No. 61/781,554 is incorporated by reference herein in its entirety for all purposes.

### BACKGROUND OF THE INVENTION

1. Field of the Invention

The invention relates to an integrated system for collecting and storing patient and medical provider data, together with providing the ability for a medical provider to review patient data, communicate with a patient, provide a diagnosis, prescribe medication for treatment of the patient's condition, including electronic coupon distribution and adjudication, document the treatment plan for each patient, and share information and images with other providers as in a provider to provider consultation or in the submission of a sample for dermatopathology. More particularly, the system electronically interconnects a plurality of data input/output and storage devices for the coordinated evaluation, diagnosis and treatment of medical conditions.

2. Description of the Prior Art

The distribution of care to underserved geographic regions remains a critical challenge to the medical profession. This is particularly acute in certain specialist fields, where the demand in urban centers is high and the number of available providers is low.

Many attempts have been made in the prior art to integrate the use of electronic network communication systems to extend the delivery of medical care. Similar to the widespread distribution of consumer goods through the use of websites and remote communication with centralized servers and data repositories, electronically distributed medical care has been attempted in a variety of ways. All cited prior art is incorporated herein by reference.

Generally, Haq, U.S. Pat. No. 7,412,396, Virtual Clinic for Medical Practice, discloses the use of remote diagnosis and treatment of patients. A patient accesses a virtual clinic and is paired with a medical professional. The physician and patient communicate electronically through the virtual clinic, i.e., website, and the physician instructs the patient to perform any necessary self examination and report the results. In certain embodiments, an insurance carrier is included in the transaction for payment of the fees associated with the visit. The insurance carrier may also perform the patient—practitioner match. The medical professional is then linked by remote telecommunications with the patient in real time and the examination follows with the patient providing all of the data to the medical professional needed to make a diagnosis and render treatment. The system incorporates real time communication between the patient and medical professional and further requires the patient to have access to a variety of diagnostic devices, such as thermometer and stethoscope. The system further provides no teaching nor suggestion of any incorporated treatment capability, other than general instructions from the medical professional. Billing and payment are generally disclosed through the reference to the insurance carrier, but there is no specific teaching or suggestion of an integrated, contemporaneous payment system.

Maeng, PCT Publication No. WO 02/082350, System and Method for Diagnosing and Prescribing Care for Remote Person's Skin by the Internet, discloses the use of an online diagnostic system for the diagnosis and prescribing of care for skin conditions, including the selection and sale of cosmetics. A series of sensors are applied to the skin at a remote location and the data generated thereby is transmitted to a central analytical server. Machine analysis of the data is performed and reported back to the user. Sensors include moisture and fat measurement sensors. The analytical server is provided with demographic and medical data by the user and a database of skin beauty data is accessed by the analytical server to assess the incoming data. Output includes information about selection of cosmetics, skin beauty management and external preparations for the skin. The system requires the use of highly specialized sensor devices for measuring the physical characteristics of the skin. The diagnosis and treatment are directed toward the selection of cosmetics and other topical skin care products and not the correction of medical conditions. The output is in the form of recommendations, and there is no teaching nor suggestion of the delivery of treatment in the form of prescribed medications and protocols.

Bandic, et al., United States Patent Application Publication No. 20120185064, Skin Analysis Methods, discloses the use of a system similar to those identified above, in that a patient is electronically placed in communication with a computerized system, which collects certain demographic and medical data. Images may be provided by the patient or utilizing particularized imaging equipment. While the reference teaches the provision of product recommendations and the use of point of sale techniques to sell such products, there is no appreciation for the use of the system for prescribed treatment and restricted prescription medications. The reference also fails to include any reference to payment systems.

The field of dermatology is one which suffers most specifically from a shortage of practitioners relative to the general population. This is most acute in rural areas or other geographic locations away from urban centers. It is also a field which lends itself more appropriately to online care. A number of examples are available in the prior art which are specifically directed to the provision of dermatological care in the online environment. More specifically, Kislal, United States Patent Application Publication No. 20110286643, Systems and Methods for Monitoring the Condition of the Skin, teaches the use of a remote system to capture a user-generated image and provide analysis and treatment. In Kislal, a user uploads an image, most particularly in the form of a digital photograph, of a skin feature to a computing device. The computing device is programmed to identify the skin feature through the use of a library or database of images and to compute certain physical characteristics of the feature. The output of this process is an analysis of the skin feature and, in appropriate circumstances an analysis of changes in the feature over time, if a library of images has been stored. The images and/or analysis can be uploaded to a remote server through the use of the Internet or other electronic network. Remote processing is also contemplated. In conjunction with the teaching of Kislal, the assignee of the reference, Skin of Mine Dot Com. LLC maintains a website at www.skinofinine.com. This website provides for the upload of digital images of dermatological conditions, input of demographic and medical information, analysis by a medical professional in an online context and recommendations for care. The recommendations may include prescriptions, but no teaching or suggestion of online direct pharmaceutical fulfillment or consultation. Electronic payments are accepted.

There remains a need, therefore, for an integrated system which provides online dermatological consultation services with and between qualified medical personnel (e.g. other providers and/or pathologists), but which further includes the ability to receive electronic payments, automatically document each patient's treatment procedure, have the ability to request new images or medical information from patients for optimal diagnosis, store the relevant records and directly prescribe medications. A need may also exists for the ability to communicate securely back and forth between the patient and medical provider to provide better care or refine care (receive timely updates) based upon the progression of the condition during treatment. A need may also exist to triage a patient into an office for severe conditions in a very timely manner to stop the progression of a life threating disease, for example in the case of melanoma. There is also a need for the ability to maintain a patient's history of prior care such that this history can be referenced at follow-on care visits or new care visits when the patient's history may have importance in providing a better picture for medical diagnosis. The provision of prescription medications is not a trivial or obvious improvement to the other prior art systems, as electronic recordkeeping and drug interaction data must be integrated within the system as well.

### SUMMARY OF THE INVENTION

An online medical consultation system is disclosed which provides all of the missing features of the prior art in a coordinated program. The system is freely and widely accessible through a website portal utilizing only a generic Internet browser on any device capable of communication with the network. While of more limited applicability, the system could be adapted for a private or more limited electronic network.

The system includes a central portal server, which is in electronic communication with a payment server, a prescription database server, a plurality of pharmacy servers, a plurality of users, a plurality of medical professionals, a CRM database, an ERP web server, an HIE database web server, and a surescripts database web server. The preferred method of interconnection is through the Internet.

In practice, the portal server is utilized to enroll a plurality of medical professionals and issue a credential to each for access to the portal server and its data. The medical professional will be associated with an account which tracks usage, patients and payment information. Each medical professional will provide appropriate evidence of competency to practice medicine as a part of an integrated onboarding (credentialing, training, agreements, system setup) process and be assigned a defined territory associated with that individual's licensure. In the event that multiple medical disciplines are contemplated for service by the portal server, each individual medical practitioner will also be assigned at least one technical area of practice. In the preferred embodiment, the specialty of dermatology is contemplated as a single area of practice for the portal. It is to be specifically noted that any number of medical, dental, forensic or animal specialty practices, or general practice and care delivery models (triage, consultative, direct care, emergency, disease management), may be accommodated simultaneously or on individual portals.

Once a staff of medical professionals has been assembled, the portal server is utilized to enroll a plurality of users in the form of patients for the medical professionals to provide care for. Each user is also issued a credential for authentication and coordination of medical and payment records. As part of the initial visit, authentication in the form of identification of the user will be accomplished through the furnishing of evidence or other factors which provide reasonable assurance of identity and competence to consent to treatment. Accommodations for minor patients and parental consent, as well as surrogate consent for patients that do not have the mental/physical/technological capacity to perform care for themselves, are also implemented. The user will also provide basic demographic, physical, medical and care preference data which is relevant to diagnosis and treatment. Preferably, an initial data screen will include a series of questions which establish the ability of the user to comply with the remote diagnosis and treatment protocol. Additionally, a relevant medical history, including all current prescriptions, allergies, past medical procedures, genetic history, and relevant nonprescription drugs and supplements will be taken and incorporated into the patient records for optimal treatment.

Finally, payment information will be provided by the user, preferably in the form of electronic payment instructions, e.g., a credit card or other bank authorization information. It should be specifically noted that the payment system may include an insurance carrier incorporating co-pay arrangements. While it is preferable that billing is performed on an immediate basis, it is clearly contemplated as within the scope of the invention to include more conventional billing practices, including the submission of invoices, in either tangible or electronic form.

Once the initial visit is completed and the patient's demographic profile and care preferences are selected, a patient record is created which includes all of the relevant background information. The patient is then fully enrolled and proceeds to a phase of the visit which includes the exchange of information relevant to the specific medical condition for which the patient is seeking treatment. This may be in the form of an initial visit or a follow up visit, in which prior medical information and images may be available for comparison and further analysis. The patient provides medical information in accordance with an evidenced-based protocol in the form of a series of web pages or mobile applications integrated with such web pages. The web pages and/or mobile applications include the ability of the patient to upload relevant images, instructions for taking appropriate digital pictures to illustrate the condition, free and guided response questionnaires relating to the condition and its effects on the patient and other relevant information. At the conclusion of this phase of the visit, the patient records are updated and any payment processing is completed. As an additional note, the system may be arranged so that the patient can save data at any point in the care visit so that they may leave an unfinished care visit at any time and come back to complete the rest of the visit since the data can be saved along the care visit continuum.

The portal server may be an integrated device or its functions may be distributed among several servers, as would be apparent to any person skilled in the art of website or network architecture. The platform that implements the portal server may be highly and easily scalable and redundant to protect from data loss. In any embodiment, the portal server is in electronic communication with a database which includes all of the patient data. Medical professional data may be stored in the same database or a separate database. The portal server is further in electronic communication with a variety of other servers and/or mobile applications preferably through the Internet or other electronic data network. With respect to each third party provider, an electronic and data sharing relationship is established as part of the setup of the system to facilitate data exchange and freely permit queries of the relevant databases. The system may be designed so that the system architecture is very flexible, open and adaptable in a secure manner for ease of connectivity with outside systems. These third party servers include payment servers, Customer Relationship Management (CRM) servers, E-Commerce servers, and ERP servers which may include insurance carriers, banking or other financial institutions. First, the portal server communicates with these payment servers to request funds from patients' accounts and to deposit funds into the accounts of the medical professionals. Additionally, payment information may be provided to pharmacies and skin care product partners upon placement of orders for prescriptions for patients, as will be described more fully below.

Another electronic communication pathway is between the portal server and a pharmaceutical database server. In the preferred embodiment, this pharmaceutical server maintains a database of all prescription and other drugs as part of a formulary which serves as the pool from which prescription and other treatments may be ordered by the patients, upon authorization or recommendation by the medical professionals. The authorization may be in the form of a prescription. The patient has the ability to select a pharmacy from the majority of all pharmacies across the country. The patient may be provided with the option of filling a written, called-in, or faxed prescription through more conventional means, however the preferred embodiment integrates the prescription fulfillment process. The pharmaceutical database server also stores drug interaction data, drug to drug data, and drug to allergy data as well as provides an electronic communication gateway with pharmacies and/or other drug outlets. It is clearly contemplated that these functions may be divided among several third party providers or may be combined into a single service. In operation, the patient records relating to prior and current prescription and nonprescription drug and supplement use is utilized as part of a query when any new treatment is prescribed by the medical professional to reduce negative drug interactions in the patient. Furthermore, the pharmaceutical database server provides a payment and order fulfillment and messaging pathway to the local pharmacy selected by the patient as part of the care visit process. The pharmaceutical database server may also provide other pertinent communications between providers (medical doctors) and/or patients for other issues such as refills, prescription ready notifications, etc. The requested pharmaceuticals are selected by the medical professionals from the formulary and that data, along with the requisite payment data, is communicated to the pharmacy for fulfillment and pick up by the patient. Additionally, the pharmaceutical order may be mailed or otherwise delivered to the patient.

Finally, the portal server provides a communication link between the patient and the medical professional. Each is typically connected to the highly secured electronic communication network through a private provider of Internet or other network services. The portal server may provide real time communication, including audio, video, images and/or text, and also provides more sequential communication, such as electronic mail or stored data which is accessed upon logon to the portal website by the relevant user.

The medical information system, together with its particular features and advantages, will become more apparent from the following detailed description and with reference to the appended drawings.

### DESCRIPTION OF THE DRAWINGS

FIG. 1 is a diagrammatic view of a virtual care platform.

FIG. 2 is a diagrammatic view of a new patient enrollment procedure.

FIG. 3 is a diagrammatic view of a new patient care visit procedure.

FIG. 4 is a diagrammatic view of an existing patient record update procedure.

FIG. 5 is a diagrammatic view of an existing patient return visit procedure.

FIG. 6 is a diagrammatic view of a medical professional my patients procedure.

FIG. 7, represented by FIGS. 7A, 7B, and 7C, is a diagrammatic view of a medical professional care process procedure.

FIG. 8 is a schematic view of a machine-based system in accordance with an exemplary embodiment.

FIG. 9 is a screen capture of a medical professional dashboard in accordance with one exemplary embodiment.

FIG. 10 is a screen capture of a topical dosage calculator in accordance with one exemplary embodiment.

FIG. 11 is a screen capture of a my patients page in accordance with one exemplary embodiment.

FIG. 12 is a screen capture of a care visit summary page.

FIG. 13 is a screen capture of a treatment plan—details page.

FIG. 14 is a screen capture of a treatment plan—photos page.

FIG. 15 is a screen capture of a treatment plan—treatment page.

FIG. 16 is a screen capture of a treatment plan—messages page.

### DESCRIPTION OF THE PREFERRED EMBODIMENTS

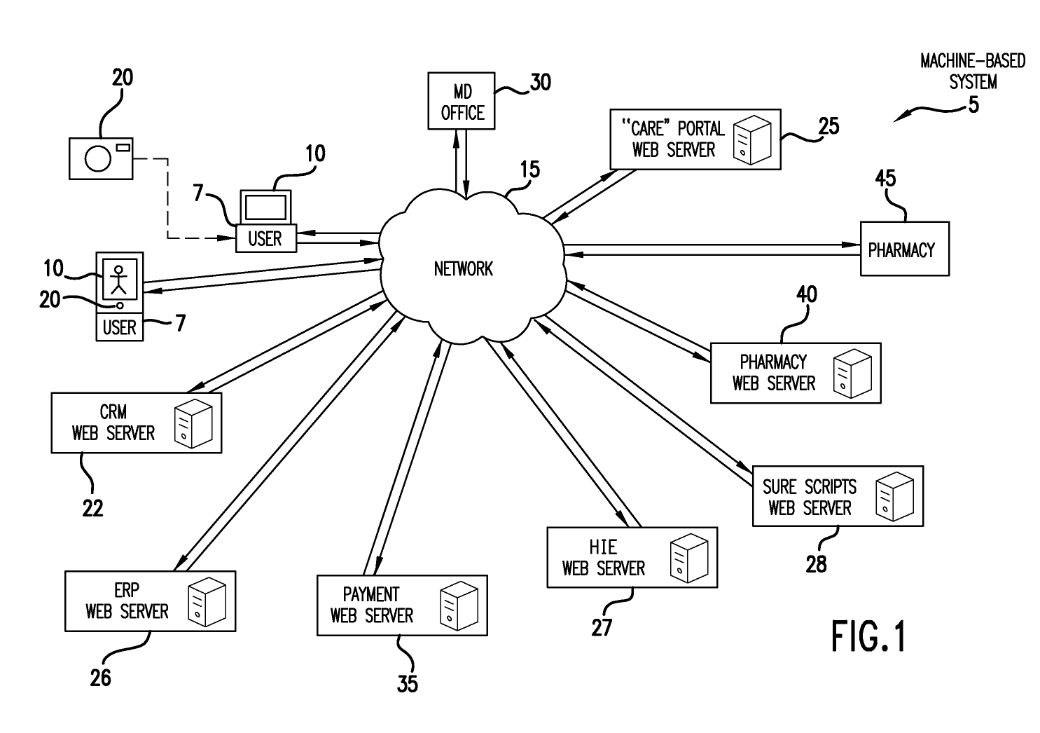

Referring now to FIG. 1, a medical system 5, that may be a machine-based system, is comprised of a series of data communication and storage devices. A user or patient 7 accesses the system 5 through an electronic computing device 10 such as a desktop computer, laptop computer, phone, tablet or any other interactive device capable of supporting a web browser program. It is specifically noted that a customized application, rather than a web browser, may be employed for certain dedicated or other web-enabled devices, such as a smart phone or tablet. For the purpose of the preferred embodiment computer 10 is utilized to represent all such devices. Computer 10 is in electronic communication with a network 15, such as the Internet. The network 15 provides bidirectional communication with all other components of the system 5. The user 7 may affix a digital camera 20 for the purpose of transferring digital images to the computer 10, or the digital camera 20 may be integrated within computer 10, or a separate digital device may transfer images directly to the network 15. The digital camera 20 may be any component capable of capturing an image in digital form and then subsequently transferring same either directly from memory or indirectly through a storage medium. The digital camera 20 may be a dedicated device, a smartphone, or a web camera. The computer 10 may be a single computer, a series of computers, and can be various computing devices such as a desktop PC, a smart phone, a PDA, or a tablet.

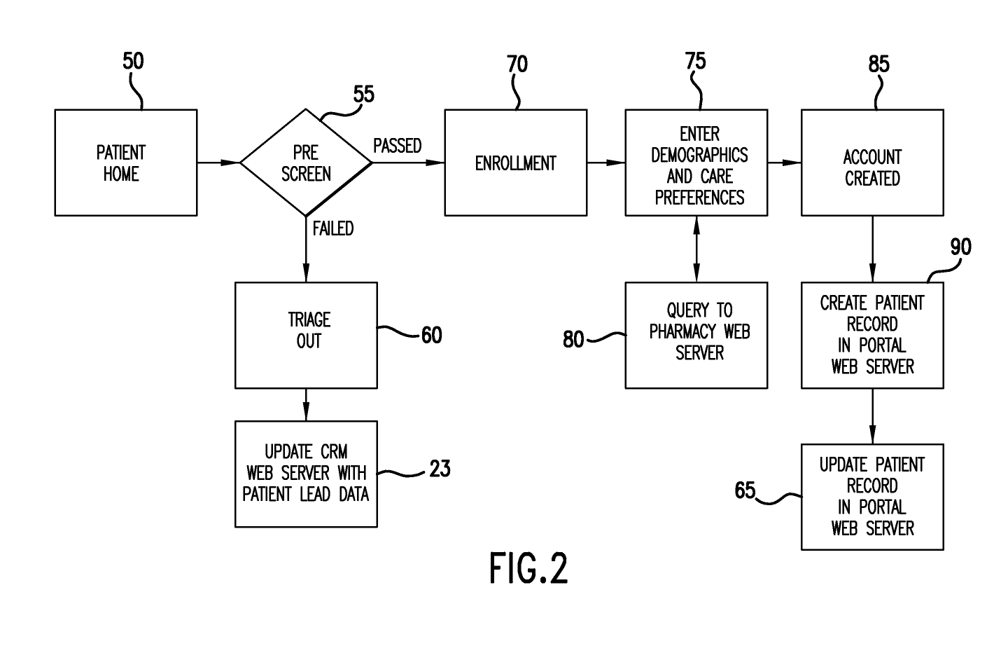

The portal web server 25, which may also be known as a care portal web server 25, is also in electronic communication with the other components of the system through network 15. As described herein, portal web server 25 may be an integrated computing device or comprise a series of servers and data repositories. Portal web server 25 is provided with the basic program instructions to manage and operate system 5, as well as manage and control access to all of the data stored therein, as will be more fully described below with reference to FIGS. 2-16. A CRM database 22 may be in communication with other components of the machine based system 5 through the network 15. The CRM database 22 may store lead records of the potential patients and be updated to show the progression of a patient lead to a patient customer receiving care thereon in some exemplary embodiments.

At least one medical professional 30, that may also represent a medical professional's office 30, is in electronic communication with system 5 through network 15. The medical professional 30 can operate at any location or can operate from location to location so long as the medical professional has internet access to a mobile device through a computing device with a browser such as a desktop PC, laptop, a smart phone, a PDA, or a tablet that interacts with the machine-based system 5. Although described in some of the drawings as an “office,” the medical professional 30 may work in areas outside of an office or in different offices or in areas other than offices. While medical professional 30 is represented as a unitary entity, medical professional 30 is more preferably a medical professional utilizing a computer 332, similar to the user or patient computer 10 and is in electronic communication with network 5 through a variety of telecommunication methodologies which are well known to those skilled in the art. Medical professional 30 accesses system 5 through a web browsing program in a like manner to the user 7.

At least one payment server 35 is in electronic communication with system 5 through network 15. As with the medical professional 30, payment server 35 is typically comprised of a series of servers which facilitate the transfer and storage of electronic funds transfer data, as well as financial account data for medical professional 30 and the patients 7, and financial customer service surrounding the payment facilitation process. An ERP web server 26 is likewise in communication with various elements of the machine based system 5 through the network 15. The ERP web server 26 provides accounting services along with other various business and financial related workflows and processes to the machine based network 5 to accomplish tasks such as determination of money owed to specific providers for services, money paid by patients 7 for care visits, and other charges and payments that relate to the machine based system 5. This information may be sent to the payment server 35. The payment server 35 may not perform accounting functions but may be the actual mechanism for effecting payment or receiving payment for different entities in the machine based system 5.

At least one pharmacy database server 40 is in electronic communication with system 5 through network 15. As above, pharmacy database server 40 is typically comprised of a series of servers which provide drug formulary, drug and allergy interaction and pharmacy communications services. More particularly, pharmacy database server 40 comprises a medical database of all available prescription drugs and other materials from which medical professionals 30 select and build treatment options for patients 7. Pharmacy database server 40 provides a query interface which is in communication with portal web server 25. Pharmacy database server 40 further provides access to the included medical database and delivers as partial output a menu of the contents of such medical database to medical professionals 30. Medical Professionals 30 may then select the necessary treatment options from such menu and transmit the same to pharmacy database server 40 for ultimate delivery to pharmacy 45, as will be more fully described below. The machine based system 5 may include a surescripts database web server 28 that is in communication with the pharmacy database server 40, the pharmacy 45, and the portal web server 25 through the network 15. The provider can request a prescription and this request can be sent to the surescripts database web server 28. The request or ordering of the prescription can come from the pharmacy database web server 40 or the portal web server 25. The surescripts database web server 28 maintains prescription information and sends an electronic prescription to the pharmacy 45 through the network 15 for fulfillment.

The machine based system 5 may also include an HIE database web server 27 and EHR web servers of other health care delivery systems or physician practices that could be in communication with various components of the machine based system 5 through network 15. Information on the patient 7 can be sent to the HIE database web server 27 and stored thereon. The HIE database web server 27 may include medical data on the patient 7 from various sources. For example, the information from the machine based system 5 on patient 7 can be stored in the HIE database web server 27 along with other medical information from other machine based systems. In this regard, the HIE database web server 27 acts as an external depository of medical information for the patient 7 from a variety of sources so that the patient 7 has all of their medical information in one spot at a geographically regional and/or national level.

Referring now to FIG. 2, a user 7 accesses system 5 through a web browser and establishes an electronic communication session with portal web server 25 through network 5. This access may be facilitated by an electronic link or hypertext referral from a provider website or other electronic communication. In light of the exchange of personalized health information, all such transmissions are encrypted for security. As part of an initial visit to system 5, the user 7 lands on a home page 50 which provides information regarding system 5 and a choice of login or enrollment in system 5. The information presented can include a plethora of educational information that allows the user 7 to better understand the method/process of care, the condition the user 7 may have, and why this may be the best alternative to receive care. The home page 50 may also in some exemplary embodiments present various social media avenues for patients to utilize to build community with each other and share knowledge to enhance present and future care experiences.

A user 7 who has previously visited system 5 and has already enrolled may authenticate and skip directly to treatment or other functions. A first time user 7 will be directed through a series of web pages which will facilitate enrollment in system 5, which includes setting up authentication. As a preliminary matter, user 7 may be asked a series of questions at prescreen step 55 in order to establish the user 7's ability to functionally operate system 5, qualify for online care, comply and be eligible for care with the requirements of system 5 or the treatments provided by medical professional 30. Prescreen 55 may include obtaining demographic and/or physical data from user 7, including the geographic location and/or state in which the patient is to be treated. This is particularly relevant to the assignment of appropriate medical personnel having licenses to practice medicine in the designated geographic area.

In the event that user 7 fails to meet the preselected criteria for enrollment into system 5 as a patient, user 7 is directed to a triage out 60 which may provide information to user 7 regarding their unsuitability and make recommendations for other care alternatives. Alternatively, triage out 60 may merely indicate the end of the session. The procedure including triage out 60 concludes with an update to a patient lead record in CRM database 22. This stored information can be used to send communications to the potential patient for future care, and which are stored so that if user 7 attempts to enroll in the future, the information already provided remains available. At step 23 patient lead data is sent to the CRM database 22 and is stored in the CRM database 22.

In the event that user 7 passes prescreen 55, user 7 is transferred to a series of informational pages which outline the services offered by system 5, as well as any rules and/or service expectations and obtaining proper consents. User 7 is then transferred to enrollment sequence 70. This sequence includes a series of web pages which request authorization and provide for informed consent to treatment. User 7 provides demographic information at step 75 including name, address, treatment location, which may be different from the patient's address and security authentication data. In the event that user 7 is a minor, parental consent data is requested. Care preferences of the patent may also be entered at step 75, and one or more images of the disease condition or item in question may be entered into the system at this step 75 as well. In the event that the patient 7 is incapacitated to care for himself or herself, surrogate consent data is requested. Steps 70 and 75 may be combined or rearranged in any manner. A patient identification photo may be uploaded here and/or at step 115. Additionally, at steps 70-75, pharmacy selection and preference of RX drug type (generic vs branded) information is provided, which will be the ultimate delivery point for any treatments ordered by medical professional 30. Further, at steps 70-75 a preferred medical provider (medical doctor) may be selected by the patient 7 and this is the medical provider that may be assigned to the patient 7 for purposes of medical evaluation. Patient 7 may place themselves on a general waiting list for selection by an available medical professional or may be provided with a list of authorized medical personnel having appropriate licensure within the geographic territory in which patient 7 resides. If presented with a list, patient 7 may choose an available medical professional for his or her preferred care provider.

The patient 7 may enter demographic and care preferences at step 75 that may include account and security information, mailing information, age, communication information and preferences for communication, pharmacy selection, drug preference selection, and care provider selection. A query is transmitted to pharmacy database server 40 at step 80 to assist the patient 7 in properly searching for, finding, and selecting a particular pharmacy for treatment. At the conclusion of steps 70-75, portal web server 25 creates a final patient record at account creation step 85 which includes preselected formatting of all data received from user 7 into a database stored in conjunction with portal web server 25 and the portal web server 25 is updated at step 90. The patient record of the portal web server 25 is updated as necessary at step 65. At this point the user 7 is enrolled in system 5 as patient 7.

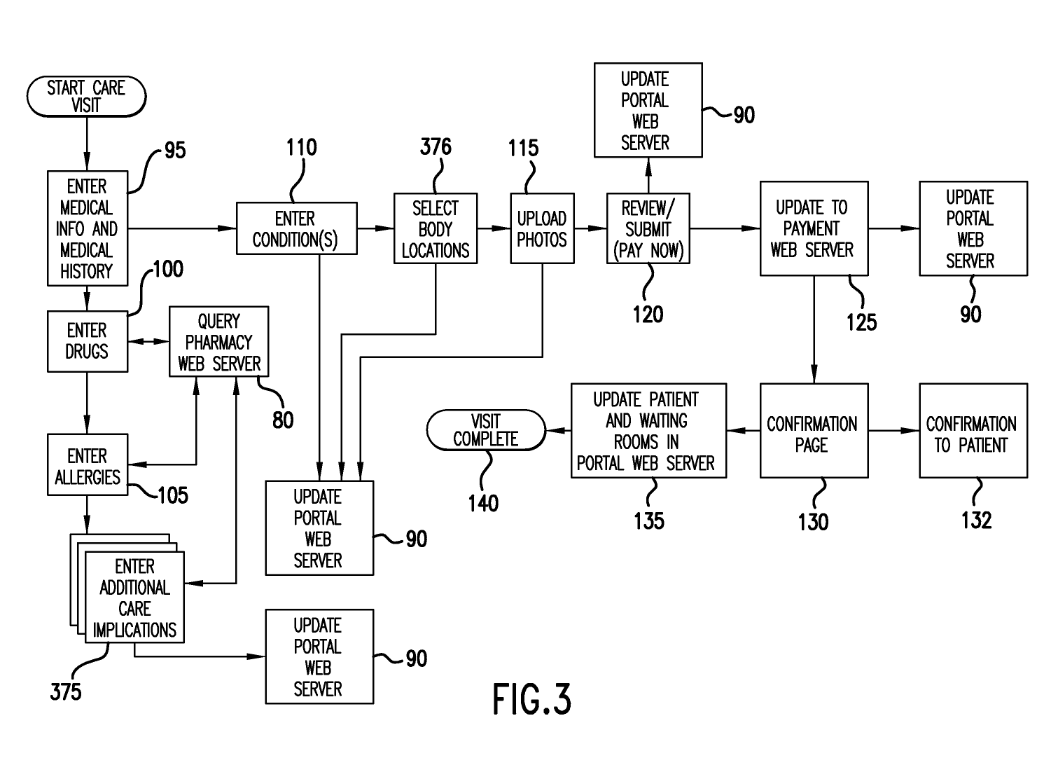

Referring now to FIG. 3, patient 7 starts a care visit and at step 95 enters medical information and medical history that may include all current and/or past illnesses and typical past medical history information as would normally be collected as part of a typical office visit to a medical professional and are well known in the prior art. In the event that patient 7 is returning to system 5, for example the patient 7 may save the care visit at various steps in the care visit process and come back to finish the care at the point of saving, and initiating the visit at this page, authentication procedures are initiated to ensure the identification of patient 7. As an initial step, patient 7 will be requested to provide for the first time or update (if the patient 7 had previously entered and then saved information for later processing) certain critical medical information, such as relevant prior medical history, changes in drug use status 100 and/or allergy status 105. Additional care implications may be entered for the first time or updated as necessary at step 375. Any changes in status, for example any changes in drug use or allergy information, will require a query to pharmacy database server 80 to verify that it is a correctly entered drug or allergy to be used later in the care treatment process. In this regard, an auto search process may be implemented as the data is entered. The portal web server 25 at step 90 can then be updated. Although the additional care implications 375 are illustrated as sending a query to the pharmacy database server 80, this is an optional step as there may be certain ones of the additional care implications 375 that do not need to send a query to the pharmacy database server 80. The steps previously mentioned are not necessary in all embodiments as certain patients 7 may be totally healthy with no medical history, medications, or allergies.

After the completion of any baseline medical history data changes, patient 7 begins the visit for the substantive purpose of diagnosing condition and appropriate treatment plan. Condition entry 110 includes a series of preformatted web pages which include free and guided response questions for eliciting the precise nature of the condition. Condition entry 110 may include text responses, as well as graphical representations of the body, certain body features and standard terminology for accurate representation. Example photographs, drawings or other illustrations may be provided in addition to textual instructions for educating patient 7 in the description and representation of the condition. The patient may then be asked in step 376 to select body locations. In this regard, a graphical representation of a body may be presented to the patient and he or she may be asked to select certain locations that correspond to areas that treatment is sought or areas where problem conditions are occurring.

Photo upload 115 provides a series of web pages which instruct, receive and may also evaluate the uploaded photos for suitability. The image(s) provided by the patient 7 can be digital pictures of the condition that the patient 7 would like to have diagnosed. For example, if a rash is on the patient's 7 leg then the digital picture can be a picture of the patient's leg that shows the rash. Patient 7 may be directed to annotate each photo with certain information, such as body area and description of the condition for this body area, which may be stored as metadata or in the patient record. Photo upload 115 concludes the substantive visit to system 5. Uploaded photos may be stored in any conventional format, including compressed formats. Integrity of the images is ensured throughout the process for accuracy and to appropriately diagnose the condition. Condition photos can effectively be uploaded and managed to obtain a proper condition image set through all computing devices. Implementation of the patient's access through a mobile device, such as a smart phone, may improve use of the machine-based system 5 as the digital camera 20 may be incorporated into the smart phone thus allowing for easier uploading into the user's computer 10. Additionally, images and textual medical records may be assembled into transferrable files for interchange with other electronic medical records systems or Health Information Exchanges (HIES). The portal web server 90 may be updated as necessary upon the completion of steps 110, 376, and 115. Again, it is to be understood that the patient 7 may at any one of these steps 110, 376, 115 save their information and leave the system 5 and then subsequently return to the care visit at the save point to then complete the care visit.

At the conclusion of the visit to system 5, patient 7 will provide payment authorization information to portal web server 25. Specific payment data, such as bank account numbers or credit card numbers may be provided by patient 7 at the time of enrollment or at step 120. In either event, authorization for the visit to system 5 payment must be made at payment authorization step 120 for completion of the services. If the patient 7 is triaged out such that an office visit must be made and the medical diagnosis cannot be completed by the medical provider of the virtual care system, a refund of the payment made will be executed. In the event that the service is sponsored or reimbursed by a third party, such as an insurer, insurance information may be provided in lieu of payment. Additionally, sponsored links, marketing material and other promotional information may be provided at payment authorization step 120 or any other page or step of the process. Update 90 to the portal web server 25 of the patient records 90 may occur at several points, including following the payment authorization 120. Portal web server 25 initiates a query or update to payment server 125 to generate an electronic funds transfer or other debit notice to payment server 35 and receives payment authorization instructions and/or funds transfer data. Patient records update at the portal web server update 90 reflects the appropriate payment and clears patient 7's records for transmission to medical professional 30 for evaluation.

Patient 7 is informed of the successful authorization and payment at confirmation page 130 and may be issued an electronic confirmation 132 in the form of email, text message or other notice. However, it is to be understood that messaging to the patient 7 may take place at any point in the implementation of the virtual medical care process described herein. Patient 7's records are then granted an active wait status for review and treatment by an appropriately licensed medical professional 30 and placed on a waiting list at step 135, based upon selection by the system or patient 7's preference and/or selection. Further, the patient 7 may also have the capability to take himself or herself out of the waiting room to update additional data and can resubmit themselves back to the waiting room for care at any time before the provider selects and provides medical care. Patient 7 is informed of the completion of the patient care visit process to system 5 at concluding web page 140 that is the patient's authenticated web page. Subsequently, the patient 7 may receive notice via text or email when the care visit has been reviewed by their provider and of next steps in the care process. The next steps may be review and execution of their treatment plan, the replacement of images or the addition of new images, or the scheduling of a future care visit.

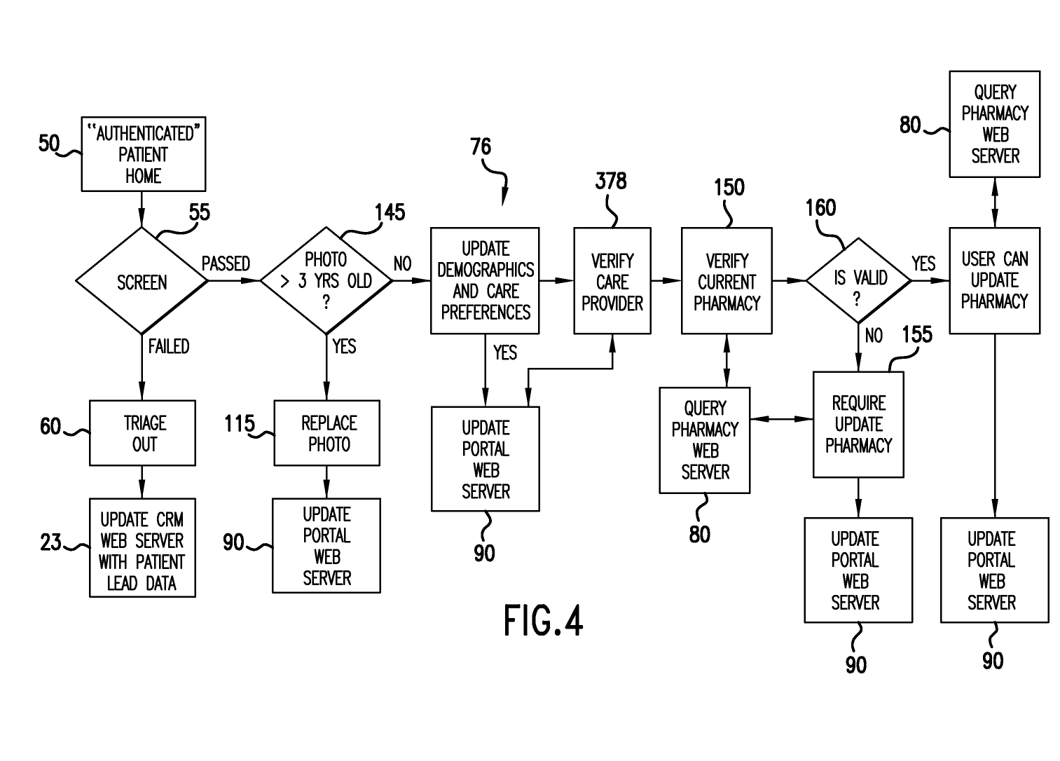

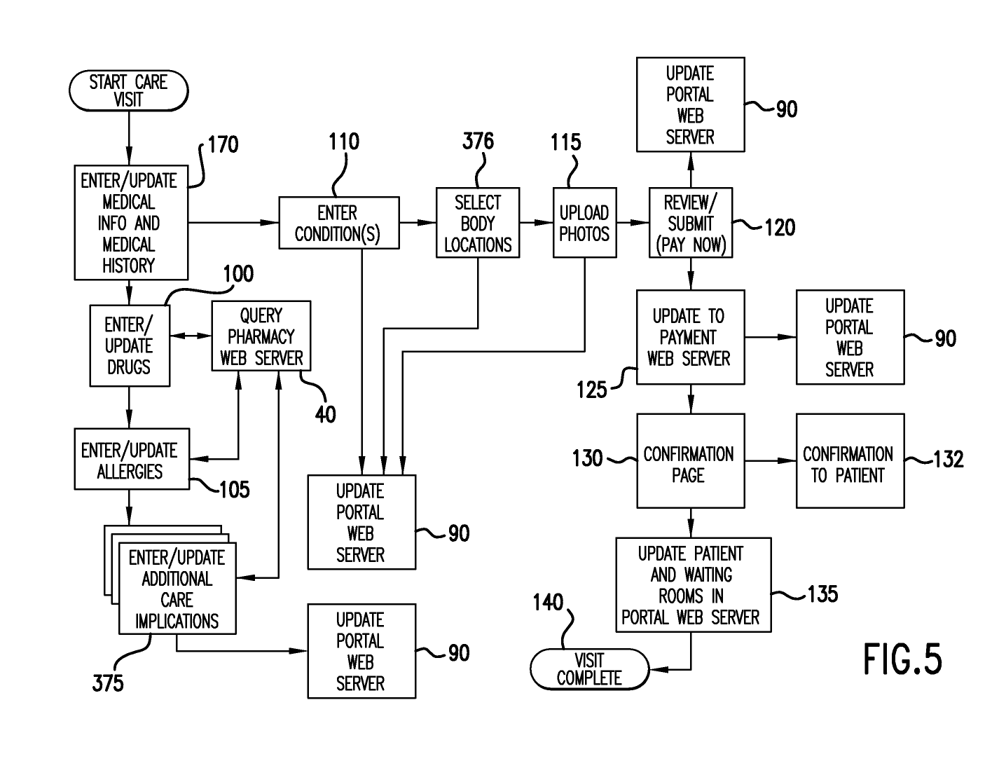

Referring now to FIG. 4, a general home page 50 may be presented to the patient 7 and once proper login and authentication is conducted the patient 7 may be presented with an authenticated patient home page 51 that is different than home page 50. A returning patient 7 may desire to update certain information stored in his or her patient records, or may want to start a new care visit or complete an incomplete session from a previously started visit. In the event of starting a new care visit or completing an incomplete record, patient 7 will be presented with the appropriate incomplete page and reenter the sequence illustrated in FIG. 4 at that point. On a new care visit, patient 7 will be required to pass prescreen sequence 55 and, if a failure is encountered, be triaged out 60. A CRM database 22 is updated with patient lead data at step 23 after the triage out step 60.

Upon returning to system 5, patient 7's front profile image(s) on file are checked for currency at photo date check step 145. In the event that the photo is deemed dated in accordance with preselected criteria, which is preferably three years, a new photo is requested at photo upload step 115 in which the photo is replaced. In other arrangements the time may be different than three years. For example, if the time is greater than two years, greater than 1 year, or greater than 6 months a new photo may be requested. Once a current photo is identified, patient 7 is required to update and/or maintain current locational or demographic information and care preferences 76 which may include account and security information, mailing information, age, communication information, pharmacy selection, drug preference selection, and care provider selection. This information is then stored via the update to the portal web server 25 at step 90.

The system then moves onto step 378 where the patient 7 is asked to verify his or her care provider which may be a current care provider or a changed care provider. The patient 7 may use a new or different care provider for each care visit, or may use the same care provider for all visits. This may be the doctor that the patient 7 wants to have treat his or her medical condition. The portal web server 25 is updated at step 90 after selection at step 378.

Finally, patient 7 is requested to maintain a current pharmacy. It is to be understood that in other arrangements verification of the pharmacy at page 150 can be performed before the verification of care provider at step 378. A pharmacy verification step 150 initiates a query to pharmacy database server 80 to ensure that the selected pharmacy remains active within system 5 at pharmacy validation step 160. Verification of the pharmacy selected by the patient 7 may be performed by the pharmacy database server 40 and involves making sure that the pharmacy selected by the patient 7 is an active pharmacy appropriately licensed and capable of filling prescriptions. If the verification fails, patient 7 is required to update the pharmacy information 155 through search and selection queries to pharmacy database server 80 until a suitable pharmacy is identified. The portal web server 25 is updated at step 90 after step 155 with the information entered at step 155. If the patient's 7 pharmacy is valid at step 160, the patient 7 is give the option of updating the pharmacy, for example to select a different pharmacy. A query to the pharmacy database server at step 80 can be performed at this step. Once the desired pharmacy is selected, the patent records can be updated at the portal web server 25 at step 90. This concludes the update of patient 7 data.

Referring now to FIG. 5, patient 7 may return from time to time for updated review by medical professional 30 or for diagnostic or prescription updates, or to conduct a new care visit. This procedure is similar to that identified in FIG. 3. It is to be specifically noted that the output of medical professional 30's analysis may be transmitted to patient 7 by external means, such as by email, or by viewing an updated page within system 5. This return visit, or new visit for a new condition, may be created at the conclusion of a previous visit or upon notice by electronic or other means, such as an email or text message.

Upon return to system 5, patient 7 lands at return visit page 170 where he or she can update and enter new medical information and history. As an initial step, patient 7 may again be requested to enter changes in drug use status 100 and/or allergy status 105, and additional update care implications as necessary. Any changes will require a query to pharmacy database server 40 to verify that this is a valid drug interaction and/or unsuitability and may finally result in an update to the portal web server 25 at step 90.

Condition entry 110 includes a series of preformatted web pages which again include free and guided response questions for eliciting the precise nature of the condition. At step 376 one or more graphical presentations are made in which the user can select a portion thereof to correspond with the physical location of the disease element. Photo upload 115 provides a series of web pages which instruct, receive and may also evaluate the uploaded photos for suitability. Patient 7 may be directed to annotate each photo with certain information which may be stored as metadata or in the patient record. The patient record of the portal web server 25 can be updated at step 90 after the photo is uploaded at step 115 to conclude the substantive visit to system 5. Update to portal web server 25 at step 90 may be made after each one of the steps 110, 376 and 115.

At the conclusion of the visit to system 5, patient 7 will provide payment authorization information to portal web server 25. Specific payment data, such as bank account numbers or credit card numbers may be provided by patient 7 at the time of enrollment or at step 120. In either event, authorization for the visit to system 5 payment must be made at payment authorization step 120 for completion of the services. Updates to patient records at the portal web server at step 90 may occur at several points, including following the payment authorization 120. Portal web server 25 initiates a query or update to payment server 125 to generate an electronic funds transfer or other debit notice to payment server 35 and receives payment authorization instructions and/or funds transfer data. Portal web server 25 patient records update 90 reflects the appropriate payment and clears patient 7's records for transmission to medical professional 30 for medical diagnosis. Patient 7 is informed of the successful authorization and payment at confirmation page 130 and may be issued an electronic confirmation 132 in the form of email, text message or other notice. As appropriate, Patient 7's records may be granted an active wait status for review and treatment by medical professional 30 and placed on a waiting list at step 135 if further response is warranted. Patient 7 is informed of the completion of the patient care visit process to system 5 at concluding web page 140 that is the patient's authenticated web page. Subsequently, the patient 7 may receive notice via text or email when the care visit has been reviewed by their provider and of next steps in the care process. The next steps may be review and execution of their treatment plan, the replacement of images or the addition of new images, or the scheduling of a future care visit.

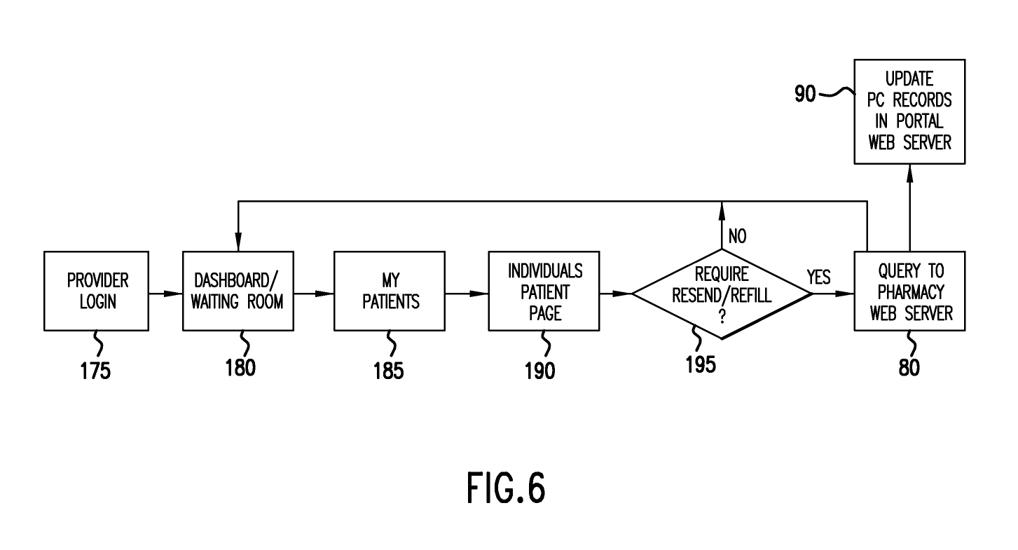

Referring now to FIG. 6, a medical professional 30 also accesses the system through the use of a credential and passes through authorization. While it is more typical that medical professionals 30 will be individually enrolled in system 5 in an offline or other independent manner, it is specifically contemplated that medical professionals 30 may initially enroll in system 5 through a procedure similar to the user 7 procedure identified in conjunction with FIG. 2. The system 5 may present the provider with a fully integrated onboarding/enrollment process that includes credentialing, training, agreement generation, and system setup. Medical professional 30 will access system 5 through a provider login page 175 which will request the user credentials issued through system 5 and any security information necessary to establish the identity of medical professional 30. Provider login page 175 may further comprise a series of login pages which provide portals to other activities, such as establishing chat or other communication sessions with patients 7, reviewing account and payment status and/or other administrative information.

Medical professional 30 is provided with a centralized data repository or dashboard 180 which provides updated patient and status information, including medical history data. This will include all patients currently assigned to medical professional 30 for treatment, as well as access to unassigned patients awaiting treatments, which are physically located within the licensed territory of medical professional 30. Medical professional 30 may then self select the number and type of patients that he/she desires to review and analyze. Dashboard 180, like provider login page 175 may provide a portal to other administrative or communications functions, including messaging services with patients. Portal web server 25 will maintain an updated inventory of patients 7 awaiting review and analysis, grouped by the elapsed time since completing their visit to system 5 and the geographic territory in which they reside. Preselected time demarcations may be established to prioritize patients 7 and to ensure prompt attention and service. To the extent that patients 7 approach a particular time or age in system status, they may be reassigned/prioritized to a particular provider or general waiting area for multiple appropriately licensed providers to select the patient 7 for care.

Medical professional 30 accesses his or her particular past or active cared for patients through the my patients view page 185, which is personal to each medical professional and limited with respect to access by authorized personnel. Each my patient view page 185 lists the past or active cared for patients 7 assigned to the particular medical professional 30 along with timing and status information. For each patient 7, medical professional 30 can navigate to a unique individual patient status page 190. Individual patient status page 190 may further comprise a series of web pages which include different reports, data and full patient EHR information, e.g., past medical history, past visit and treatment history, demographic, drug and allergy information. Individual patient status page 190 may also provide a communication portal for providing treatment, analysis and prescription information to each patient 7. In the event that an active treatment plan requires a prescription or a refill of a prescription at prescription refill step 195, a query to pharmacy database server 80 is initiated and an update of patient records at the portal web server 25 is made at step 90 to include all modified data or newly added prescriptions and an updated treatment plan is communicated to the patient 7.

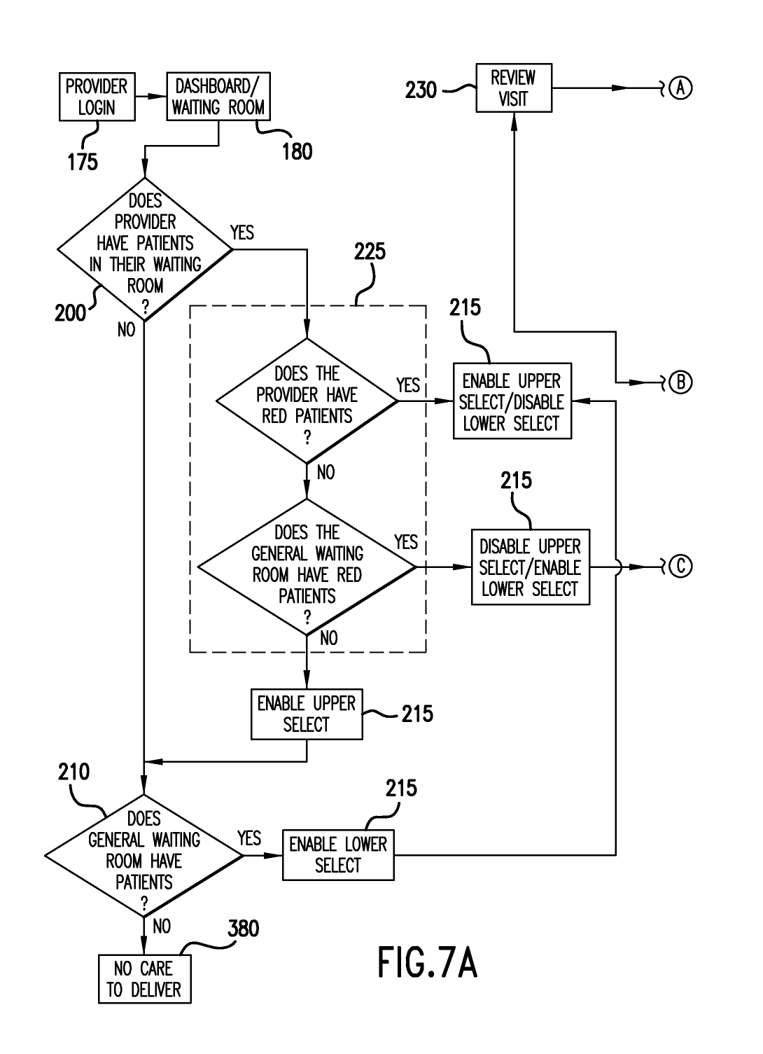

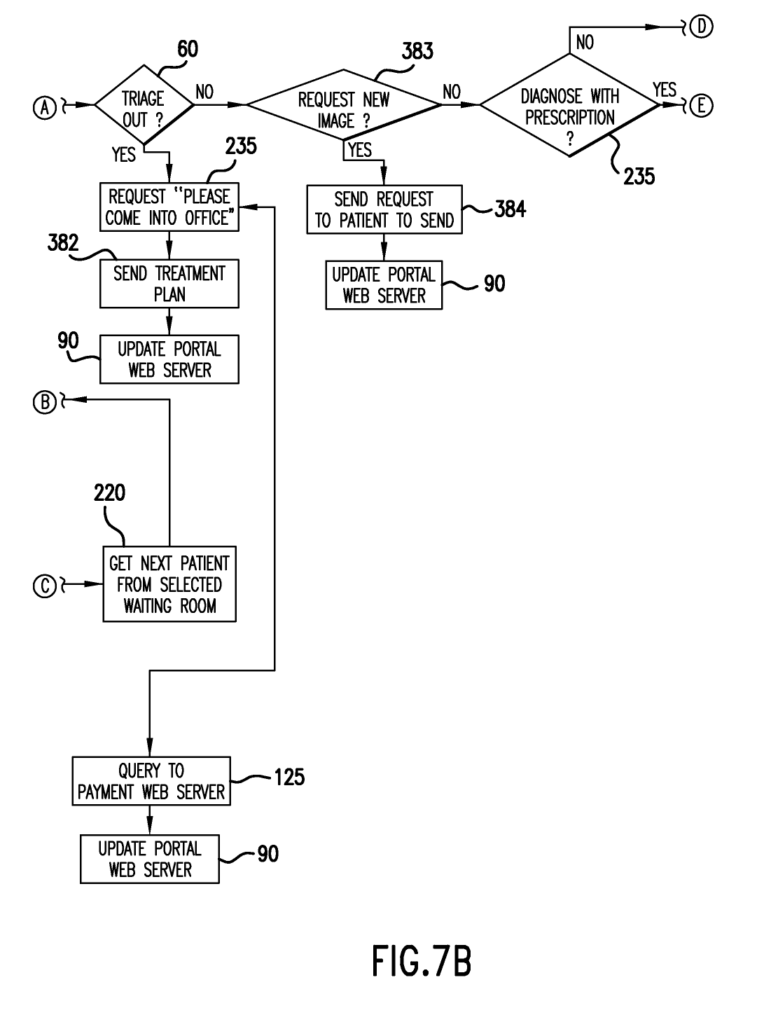

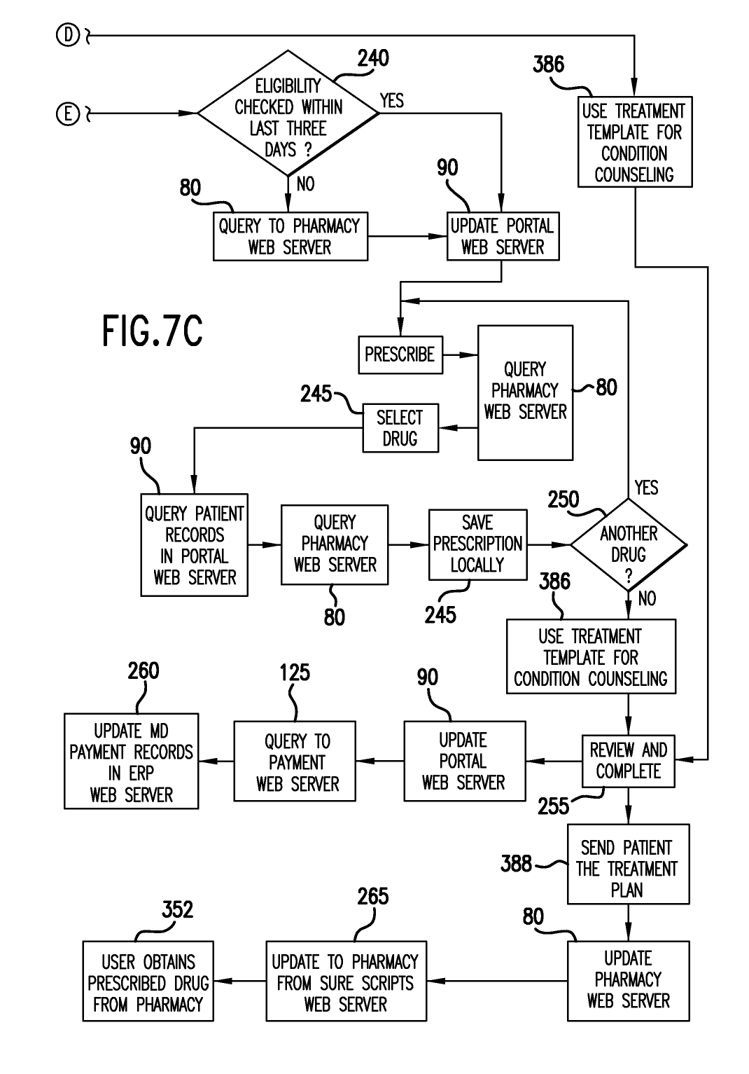

Referring now to FIG. 7, the medical provider care process procedure is illustrated in more detail. As with reference to FIG. 6, a medical professional 30 accesses system 5 through a provider login page 175 which will request the user credentials issued through system 5 and any security information necessary to establish the identity of medical professional 30. Provider login page 175 may further comprise a series of login pages which provide portals to other activities, such as establishing chat or other communication sessions with patients 7, reviewing account and payment status and/or other administrative information.

Medical professional 30 is directed to dashboard 180 which provides updated patient and status information for patients waiting for care whether in the providers personal waiting room or general waiting room. The patient priority and selection for care procedure of system 5 includes a first step of evaluating the medical provider 30's current patient inventory at provider waiting room check step 200. In the event that medical provider 30 has no inventory of patients, portal web server 25 then evaluates, at general waiting room status check step 210 whether there is an inventory of patients 7 awaiting treatment who have not been assigned to any other medical professional 30 and are within the licensed territory of the medical professional 30. If the answer is “no” then the process moves to step 380 in which there is no care to deliver. In the event that there is an inventory of patients 7 awaiting treatment, portal web server 25 selects the next patient 7 for assignment to medical professional 30 at waiting room assignment step 220. This status check and analysis is made utilizing aging criteria for the current inventory of patients 7 at criteria selection step 225 resulting in step 215. It is specifically contemplated that in the event that another medical professional 30 has not timely reviewed and analyzed his/her own assigned patients 7, that a patient 7 approaching a time critical deadline could be removed from the inventory of one medical professional 30 and selected by another appropriate medical professional 30 for more timely handling. This time critical deadline could be upon the patient waiting 1 day, 2 days, 3 days, 1 week, 2 weeks or some designated and appropriate service level requirement communicated to the patient from the time the patient provided the requested information and made payment. It is specifically contemplated that a multi-tiered priority system may be applied to patients in order to facilitate coordinated review in a timely manner, all of which would be well within the knowledge of those skilled in the art.

To the extent that medical professional has an inventory of patients 7 awaiting review and analysis, portal web server 25 assesses the general aging of the inventory of medical professional 30's personal inventory and the aging of the inventory in the general inventory. As patients 7 approach a time critical deadline, they are assigned a RED status or any other similar priority system. Status evaluation step 225 provides a descending criteria of aging priority in the assignment of patients 7 for next review and analysis by medical professional 30. Criteria selection steps 215 are utilized to appropriately direct and enable the medical provider to select the next patient based on wait time priority and pass medical professional 30 to waiting room assignment step 220 with an appropriate patient. The machine-based system 5 seeks to ensure that the patient 7 is cared for in a stated time period. If the patient 7 requests through the system 5 to only be evaluated by a particular provider, the time frames for desired care may be adjusted and extended as the time for completion of the medical evaluation may depend upon the availability and speed of that particular provider. The system 5 is arranged to maintain continuity of care between patients 7 and providers and to seek to have that care delivered in a timely, prioritized fashion.

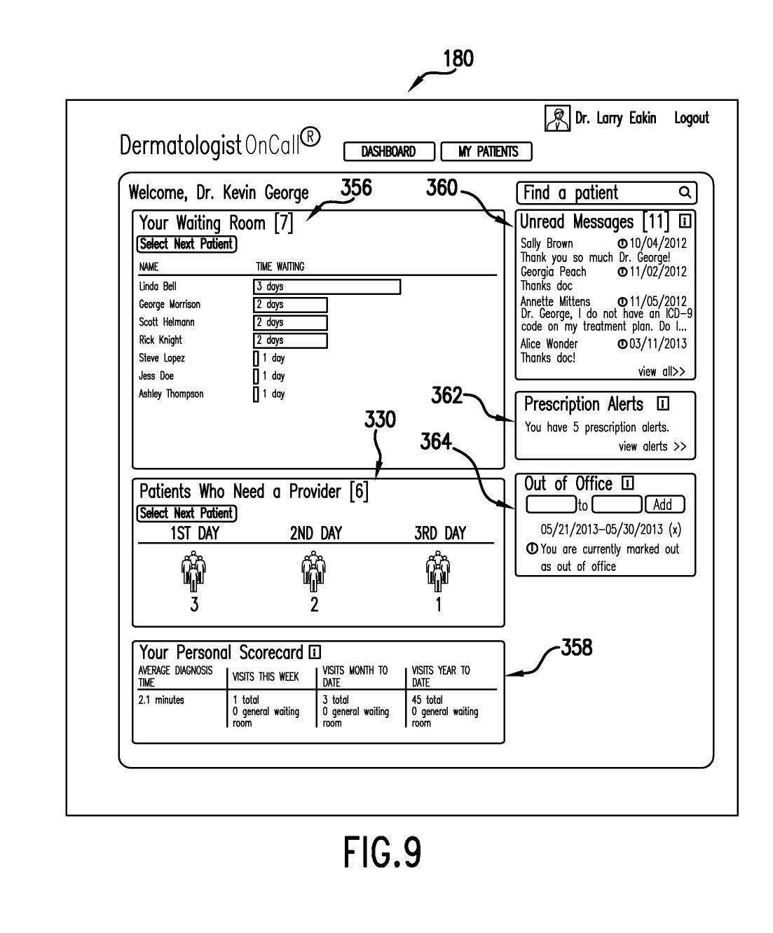

An example of a dashboard 180 that may be presented to the provider is illustrated in FIG. 9. A particular dashboard 180 for a specific provider, Dr. Kevin George, is shown having his own provider waiting room 356 that lists a series of patients along with a time period that each one of the series of patients has been waiting for his or her medical evaluation. The provider is presented with a “select next patient” button in the provider waiting room 356 that if chosen causes the provider to select one of the patients in the list. The patient selected may be the patient that has waited the longest, or the one selected may be someone in the list chosen by the provider. The provider may be presented with a drop down box or other mechanism to choose the particular patient on the list. Colors such as red, yellow, and green may be assigned to each patient in the provider's waiting room 356 to denote how long each particular patient has been waiting to be seen. Red may indicate 3 days and is shown in a bar that is longest next to the patient to indicate this long wait time. Yellow may indicate 2 days and is shown in a bar next to the patient that is not as long as the red bar. Green may indicate a patient wait of 1 day and is shown in a bar next to the patient that is the shortest in length of all of the bars.

The dashboard 180 also has a list of potential patients 330 that are those patients that need a provider and have not yet been evaluated. The patients are not identified by name but information relating to how long they have been waiting for medical evaluation is provided. This information may indicate how many patients have been waiting for one day, for two days, or for three days for medical evaluation. If the provider wishes to medically evaluate a patient from the list of potential patients 330, he or she may click on a “select next patient” button in the list of potential patients 330. The process may then assign the patient in the list of potential patients 330 that has been waiting the longest and is within the licensed geographical area of the provider so that the provider is in fact capable of evaluating the patient. The provider may not be allowed to select a desired patient from the list of potential patients 330, but may be forced by the system to be assigned to only the patient that has been waiting the longest in the general waiting room.

The dashboard 180 also includes a personal scorecard 358 of the provider that gives data to the provider such as the average diagnosis time, the number of evaluations that week, the number of evaluations to date that month, and the number of evaluations to date of that year or any monitored information that may be important to informing and improving provider's performance in categories such as patient care. Communication messages 360 are also illustrated on the dashboard 180 and are secured email messages that have been received by the provider from his or her patients for active care visits. The provider may click on a particular communication message 360 in order to read the entire message and respond accordingly.

Prescription alerts 362 are provided on the dashboard 180 to alert the provider of actions required relating to a prescription. For example, a prescription alert 362 may be provided to inform the provider that the patient 7 needs a refill or has requested a refill of the prescription. Further, the prescription alert 362 may be provided to inform the provider that the pharmacy 45 has a question to the provider regarding the prescription or for other reasons relevant to follow-up on the prescription. An out of office window 364 is also present on the dashboard 180. The provider may fill in the dates that he or she will be out of the office and not available to conduct medical evaluations. This information may be communicated to the patients in the provider's waiting room 356 to inform them that there may be a delay of service. Also, this out of office information may be communicated to patients that are registering for service so that they can, if desired, select a different provider as their designated provider that may more quickly conduct the medical evaluation. Although designated as “out of office”, the system 5 may still be arranged so that a provider even if out of office can still utilize the system 5 and provide medical care for patients of the system 5 even when so designated.

Once a patient 7 has been selected for review and analysis step 230, medical professional 30 views the patient record and makes a determination of treatment. As a preliminary matter, medical professional must first make a determination if the condition presented is appropriate for online care and can be diagnosed, or alternatively, requires personal care with an actual office visit. The medical professional may determine whether he or she can make a diagnosis online or whether the patient 7 must physically go to an office location for in person evaluation. This would be appropriate if the likely condition presented is more acute or of a type other than can be assessed properly through the use of photographs. In the event that the medical professional determines that the status is not appropriate for online care at triage out step 60, patient 7 is provided with a message through a treatment plan sent back to the patient that the condition is not appropriate for online care and requests an office visit. The request may be sent directly from the provider to the patient 7, or may be sent by a message from the web portal 25 through the network 15 to the patient 7. An additional analysis may also be made as to the physical location of patient 7, based on the patient mailing address zip code, and a referral to an appropriate medical professional 30, within a reasonable physical distance from patient 7 will be made. The medical professional to which the patient 7 is referred to make an actual office visit will be within the licensed practice area/state of patient 7. In other embodiments, patients 7 are referred only to a medical professional that is licensed to practice in the patient's 7 area. An update to payment server 125 is generated, and patient 7's fees are refunded. The treatment plan that has been generated for the patient 7 up to this point is then communicated to the patient 7 by email, regular mail, or any other means at step 382. Updates to patient records in the portal web server 25 are then made at step 90. Portal web server 25 may also provide patient 7 with the ability to schedule the office appointment online at that time and generate notices, electronic appointments for inclusion in patient 7's electronic calendar and other similar alerts.

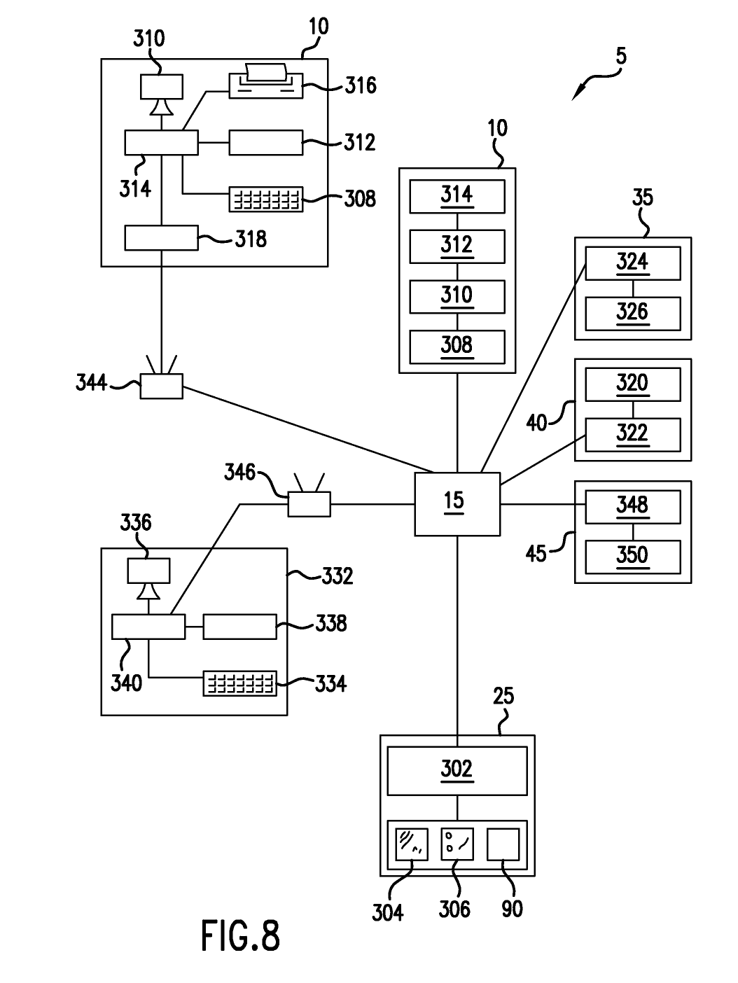

If the patient 7 is not triaged out at step 60, the medical provider may then make a determination at step 383 as to whether additional or replacement images should be provided by the patient 7 for purposes of adequate medical evaluation. The first image 304 in FIG. 8 may be a series of images or video provided by the patient 7 and not be sufficient to complete the medical evaluation. If the medical provider decides at step 383 that new or additional images need to be obtained, the process then moves to step 384 in which a request is sent to the patient 7 for new or additional images. The provider can request a second image 306 in FIG. 8 that is another or replacement image (that may include a series of images or video provided by the patient 7) from the patient 7 at step 384 via email or by updating the patient display page of the machine based system 5. The provider may provide instructions to the patient 7 when requesting the second image 306, that is another image or a replacement image, such as instructions on what types of photos to take, lighting, closeness, or any other property of the image 306 that the provider would need to make the proper medical evaluation. It is to be understood that as used therein, the terms, photo and image may be broad enough to cover not only still digital photos but also video that may or may not include audio elements. Step 90 may take place after step 384 and may involve the updating of the portal web server 25.

If a new or additional image(s) is not needed at step 383 then the system moves to step 235. If a prescription is not needed by the patient as part of his or her treatment plan, the system moves to treatment template step 386 in which prefilled treatment templates are provided applicable to the diagnosis to the patient 7 to inform the patient 7 of the medical condition and appropriate treatment, warnings and expectations. In the event that a treatment plan requires a prescription or a refill of a prescription at prescription diagnosis step 235, a query to the portal web server 25 determines at eligibility step 240 if the patient records indicate that it is appropriate to generate prescriptions for the treatment plan. This is to eliminate mistaken duplication of analysis or duplication of prescriptions. Appropriate updates to patient records at the portal web server 25 are made at update step 90 at this time, identifying the prescribed treatment plan. In the event that a prescription is part of the treatment plan, the medical professional 30 initiates a query(s) to the pharmacy database server 80 and selects an appropriate prescription(s) 245. Portal web server 25 may utilize at least one dosage calculator 342 to assist medical professional 30 in determining the appropriate topical dosage for topical prescriptions based upon the physical characteristics of patient 7 stored in the patient records.

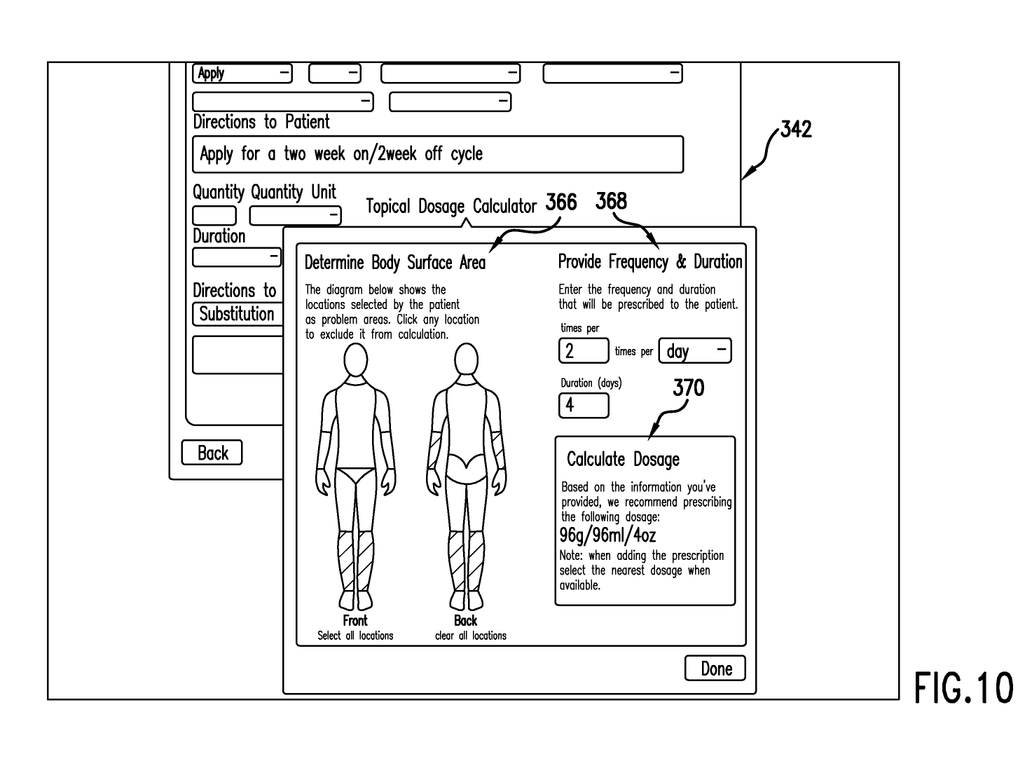

One example of a topical dosage calculator 342 is illustrated with reference to FIG. 10 and may be generated by the portal web server 25 and used by the provider. The provider may select a particular drug 352 for the patient 7 and the dosage calculator 342 may then become available on the screen display of the provider to assist in determining the proper amount of the drug 352 to prescribe. Information on the patient 7 such as height and weight can be automatically input into the dosage calculator 342, or if not the provider may manually input this information at this point in time. A body surface area 366 is included in the dosage calculator 342 and can present a graphical representation of the front and back of the patient 7. The provider may manually select areas of the patient 7 onto which the drug 352 is to be applied by the patient. Once highlighted, the dosage calculator 342 may then determine the surface area of the patient to which the dosage is to be applied. As shown with reference to FIG. 10, the back of the forearms, the front of the lower legs, and the back of the lower legs are selected by the provider as being the areas of the body to which the drug 352 is to be administered.

A frequency and duration section 368 is also included in the dosage calculator 342 and the provider will enter the number of dosage to be given in a particular time period. For example, the number of applications selected may be 2 applications and the time period selected may be per day. The frequency is thus 2 applications per day. Any number of applications may be selected. For example, from 1-4, from 5-10, or up to 20 applications of the drug 352 can be selected. The time period may be hours, days, weeks, or months. The duration information, like the frequency information, is input into a box manually by the provider without a graphical representation. The duration is the length of time the provider wants the patient to apply the drug 352. For example, the duration may be 14 days in some embodiments, but in other embodiments may be from 1-5 days, from 6-21 days, or up to 6 weeks. The frequency and duration in one embodiment may thus be 2 applications per day for 14 days. In this regard, the patient 7 will apply the drug 352 two times per day as directed for 14 days in a row and then will cease application of the drug 352.

After the proper information is entered into the dosage calculator 342 both manually by the provider, and potentially automatically from other records or entries of the machine-based system 5, a dosage output 370 on the dosage calculator 342 can give the provider the calculated dosage. The dosage calculator 342 uses the input information with known information on the drug 352, stored for example in the portal web server 25 or stored in the pharmacy database web server 40 and queried by the portal web server 25, and automatically calculates the correct amount of dosage of the drug 352 for the provider to prescribe. For example, the calculated dosage may be 4 ounces, 118 ml, or 113 ounces in accordance with certain exemplary embodiments. The provider may prescribe the amount of dosage listed at the dosage output 370 section of the dosage calculator 342 or may prescribe a different dosage. The dosage calculator 342 may be used as a tool by the provider in the selection of a proper dosage of a drug 352 but need not be binding on the final determination of a prescription dosage by the provider.

The portal web server 25 is updated at step 90 and an update to pharmacy database server 80 is initiated at this time and the prescription information is generated in a format which patient 7 can download or otherwise obtain if the online pharmacy option is not enabled or selected at generate prescription step 245. The provider may request through the portal web server 25 a prescription and the prescription request may be sent from the portal web server 25 through the network 15 to a third party vendor that in turn generates an e-prescription that is sent to the pharmacy 45. The e-prescription may be sent to a pharmacy computer processor 348 for fulfillment by the pharmacy 45 and provision of a physical drug to the patient 7 when the patient 7 goes to the pharmacy 45 or through mail to the patient 7. The machine-based system 5 may not be capable of using written prescriptions but only prescriptions that can be electronically sent to a pharmacy 45 in accordance with certain exemplary embodiments. The prescription order by the provider may be accompanied by an electronic coupon to the pharmacy web server to obtain the drug at a discount. In other arrangements, the user may have the ability to enter an electronic coupon as well at any point in the care process for use in obtaining a drug at a discount price.

Medical professional 30 has the option of selecting more than one prescription at a time as part of additional prescription step 250. Once an additional prescription is no longer needed at additional prescription step 250, step 386 is performed in which prefilled templates are generated that can provide the patient 7 with information on treatment of the disease condition, use of the prescription, warnings, recovery time, and other treatment information. The treatment template can in some circumstances be used for counseling the patient 7 after prescribing of the medicine but before review of the treatment plan for submission to the patient 7.

Confirmation of treatment plans and prescriptions are completed at confirmation page 255, which may include a series of pre-formatted web pages or other textual, graphic or medical background material providing further information to medical professional 30 or from which medical professional may select excerpts for inclusion in the treatment plan to be communicated to patient 7. The treatment plan may be sent to the patient 7 at step 388, and then the portal web server 25 can have a patient record therein updated at step 90/A message may be generated which may provide notification to the patient 7 that the diagnosis is completed and a treatment plan is ready for review. An update to payment server 125 generates a credit for medical professional 30's account and further generates electronic funds transfer consistent with such credit. An update to the medical professional 30's internal inventory and accounts is also generated at update medical professional records step 260.

The treatment plan may be sent to the patient 7 at step 388, and may be generated regardless of whether a prescription is or is not needed. An update to pharmacy database server 80 is subsequently initiated which sequentially generates an update to pharmacy 265. The pharmacy fulfills the prescription for delivery to patient 7 as the physical drug 352 is picked up and paid for by the patient 7 at the pharmacy 45. Of course, the pharmacy 45 may also mail the physical drug 352 to the patient 7 at his or her home or other location.

Although not illustrated in FIG. 7, the machine based system 5 can be arranged so that the provider at all points in time from selecting a patient for care, for example from step 180, to the point in time when the care visit is complete, for example at review and complete 255, has the option of canceling care or revising any aspect of care such as diagnosis, treatment, counseling, and care provider special messaging. The provider may for a number of reasons decide to cancel care of the patient 7 after selection of the patient 7 but before completing care. When this occurs, the patient 7 may be placed back into the waiting room and can be retrieved by the provider at a later date, or may be selected by a different provider as the case may be.

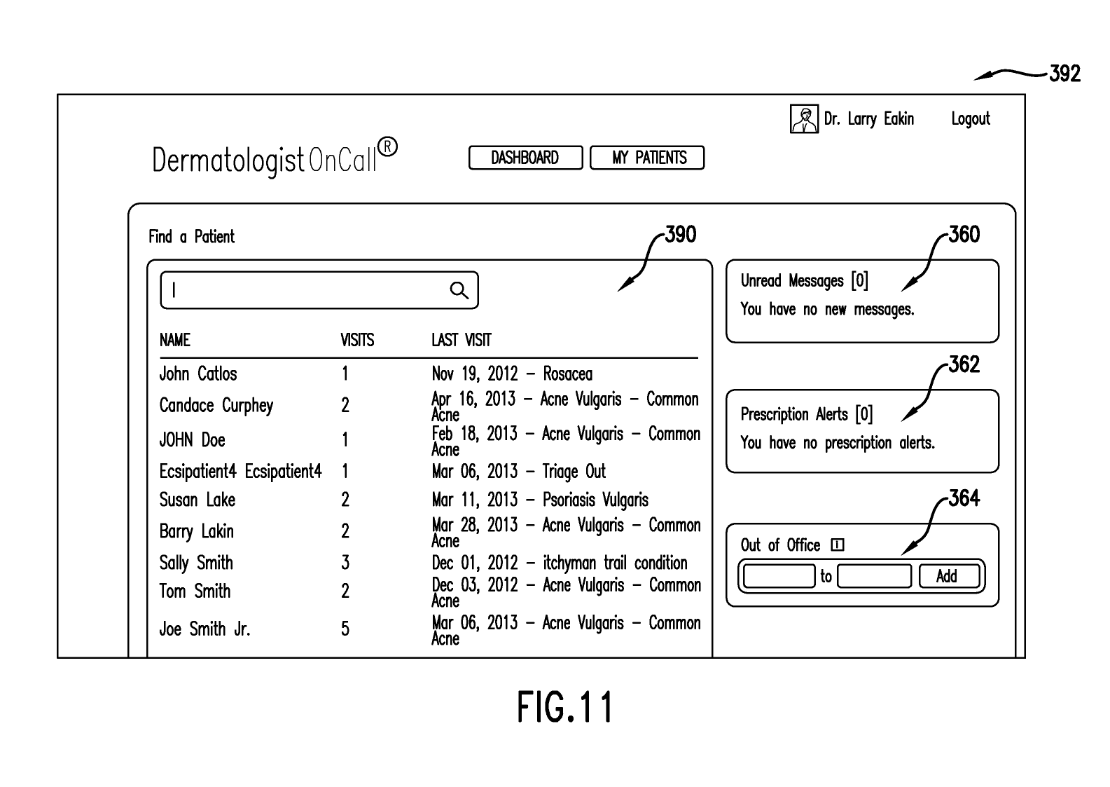

Upon logging into the provider side of the machine based system 5, the provider may be presented with the dashboard 180 as previously discussed. The screen may include a pair of selection buttons that allow the provider to switch between different views. With reference now to FIG. 11, the my patients page 392 is illustrated that is presented to a provider upon clicking the “my patients” button that is next to the “dashboard” button. Clicking on the “dashboard” button will cause the display to revert back to the dashboard 180. The my patients page 392 includes a patient listing 390 that is a listing of all of the patients of the provider. The patient listing 390 is sortable by patient name (ascending and descending) upon clicking on the “name” area thus causing the patients to be listed alphabetically by last name in descending order in the patient listing 390. The patient listing 390 also includes information relating to the number of visits and to the date of the last visit. The date of last visit also includes information relating to the diagnosed condition of the patient as on that last visit. These two items are also sortable by clicking on their respective names such that the patient listing 390 can be sorted by patients having the most to least visits, and by patients who have had the most recent visit. The my patients page 392 also includes communication messages 360, prescription alerts 362, and out of office 364 as previously discussed.

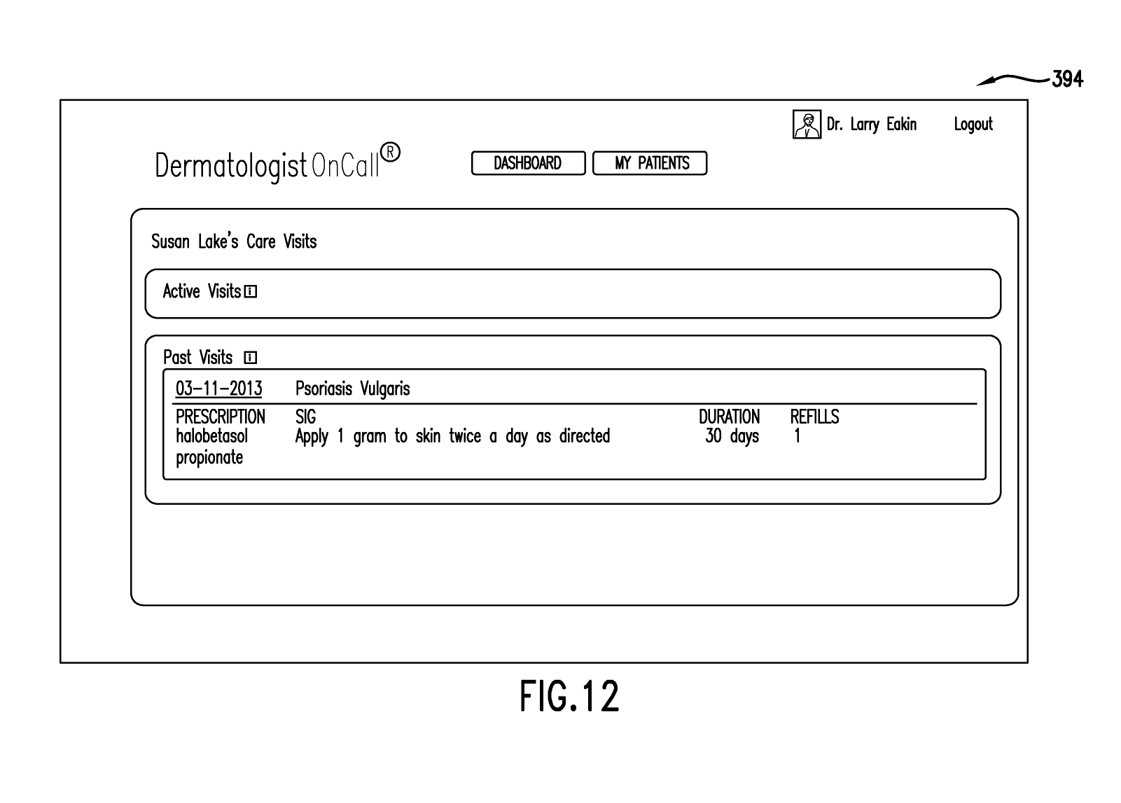

The provider may select a specific patient 7 in order to obtain additional complete care history information about that patient 7 and the visits of the patient 7. In the exemplary embodiment shown, the provider may click on “Susan Lake” and may then be displayed with the visit details page 394 as shown in FIG. 12. The visit details page 394 shows active visits and past visits of Susan Lake. There are no active visits, but one past visit that is shown. The date of the past visit along with the diagnosis is illustrated. Also shown in the visit details page 394 is the prescription that was prescribed, dosage and other instructions, the length of the prescription, and the number of refills. Although not shown as having an active visit, if such were present the care provider would be able to add one or more prescriptions to the active visit on the visit details page 394.

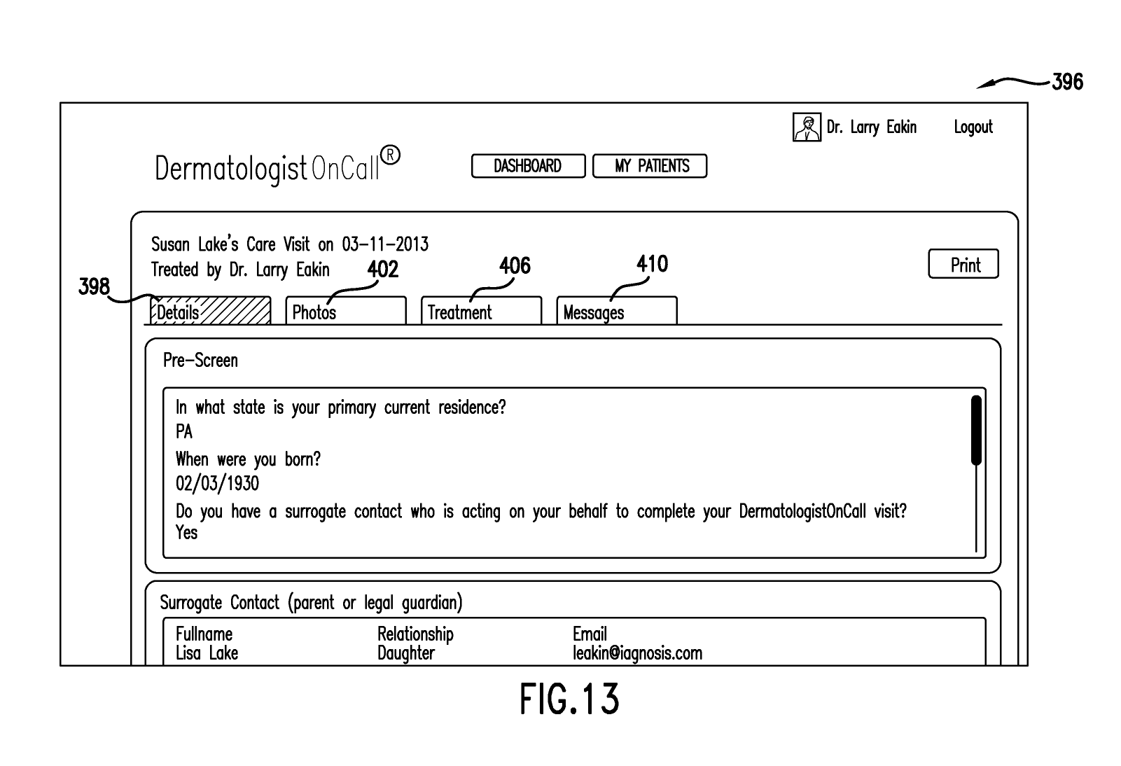

Clicking on the date of the visit causes the details page 396 (full EHR record) shown in FIG. 13 to be displayed to the provider. The details page 396 includes a details tab 398, a photos tab 402, a treatment tab 406, and a messages tab 410. Clicking on the details tab 398 will also cause the details page 396 to be displayed. The details page 396 includes information about the patient and also information specific to the particular patient visit. The details page 396 may include information from the pre-screen of the patient 7 such as the state of primary residence, birthdate, whether someone is authorized to act on their behalf, whether they are male or female, whether they are pregnant or nursing or planning on becoming pregnant, whether they agree to follow the treatment plan, and whether they agree to have the medical evaluation conducted and its charge. If a surrogate is selected, the details page 396 may also include this information such as name, relationship, email, phone number, and whether they want to be texted information. Information on the patient 7 can likewise be included on the details page 396 that relates to their account such as name, gender, birthdate, address, phone number, cell phone carrier, whether they want or prefer brand name prescriptions or generic prescriptions, and preference of pharmacy.

The details page 396 can also include a description of the patient 7 Susan Lake's condition such as name of the condition, duration of condition, severity rating (for example 8 out of 10 on a pain scale), what the condition feels like to Susan Lake, past treatments employed, any new symptoms noted, potential causes, aggravators/triggers, and any additional details such as whether the condition is worsening or if it has spread. The details page 396 can further include information that relates to where on the body the condition is located. Also, the number of photos uploaded by Susan Lake can be displayed on the details page 396.

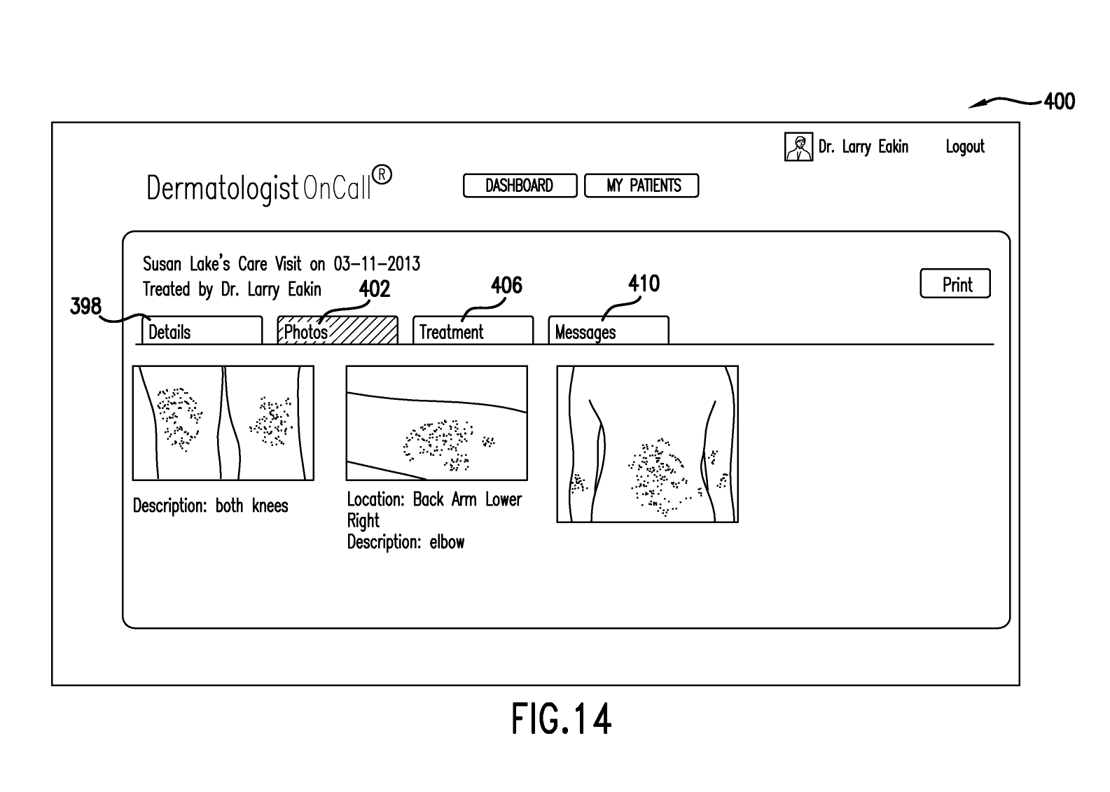

Clicking the photos tab 402 causes the photos page 400 to be displayed as shown for example in FIG. 14. The three uploaded photos of Susan Lake are shown and a description of each photo can be associated with each one of the photos. Also, the location of the photo or the condition can be noted so that the provider knows which part of the body the photo or condition relates. All of the photos need not have a description or a location associated therewith. The photos can be uploaded in relation to the particular visit, or may be from a previous visit.

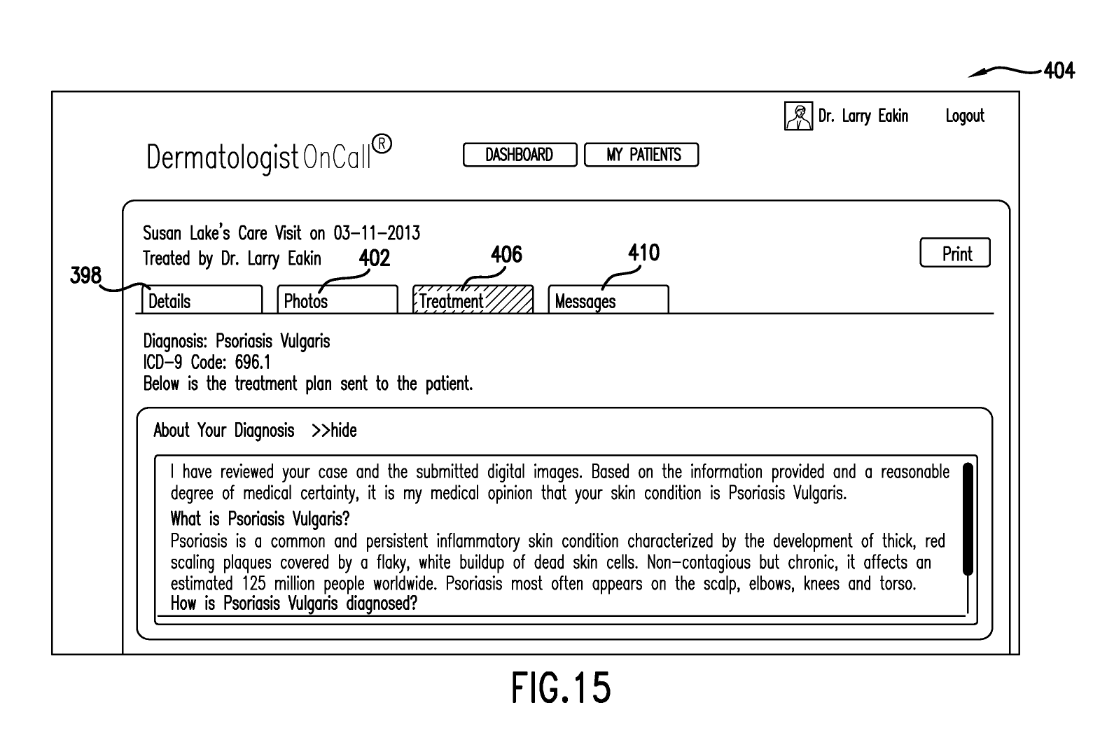

Clicking on the treatment tab 406 causes the treatment page 404 to be illustrated that shows the complete treatment plan for that particular visit. One example of a treatment page 404 is shown in FIG. 15. The treatment plan may be prefilled, template information that relates to that particular medical condition and/or prescription. The treatment plan may be customized by the provider as necessary. The treatment page 404 may display information about the diagnosis such as what the provider believes Susan Lake's condition is called, information about the condition, and information as to how the condition is diagnosed by medical professionals. The treatment page 404 may include information on the treatment details such as how the disease condition may be treated. Also on treatment page 404 can be prescription information such as the medicine prescribed, the date, the instructions for applying the medicine, the number of refills, and the length of time the prescription is to last. Also displayed is counseling information such as who gets the disease, what causes the disease, prognosis, what makes it worse, and any additional information. A message from the provider to Susan Lake may also be included in the treatment plan and displayed on the treatment page 404.

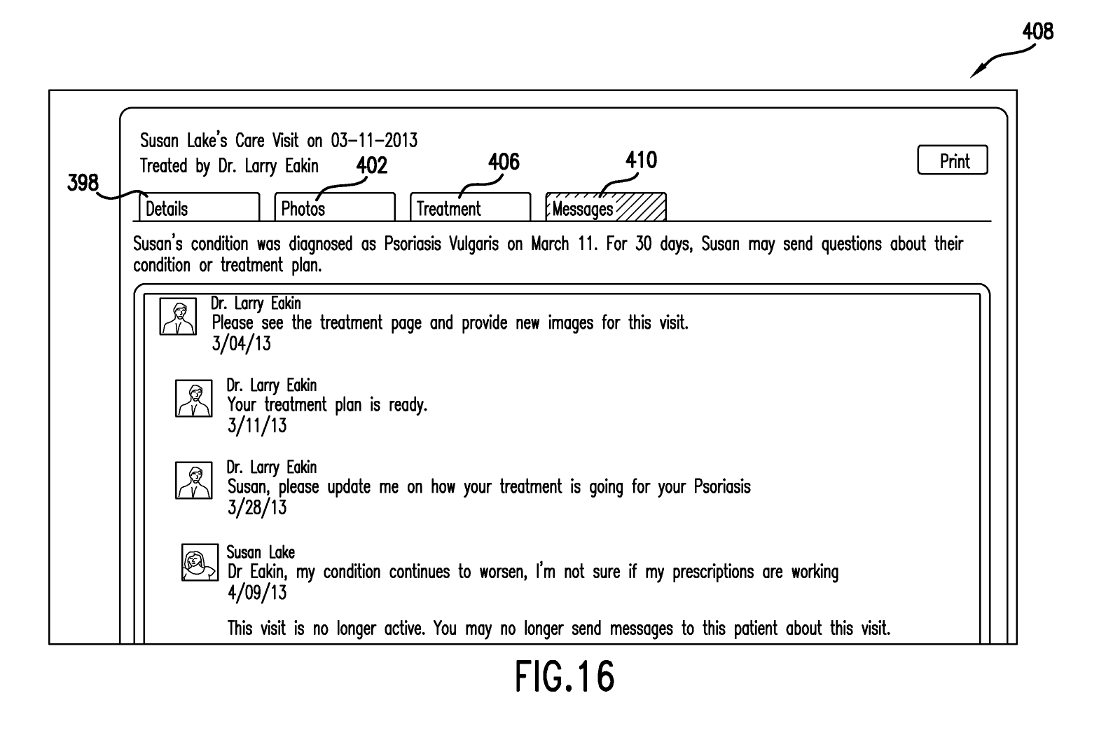

Clicking on the message tab 410 causes the message page 408 to be displayed as shown for example in FIG. 16. The message page 408 may display all of the messages that are between the provider and Susan Lake. The message page 408 may be active up to 30 days after the date of visit, which may correspond to an active visit period, such that messages between the provider and Susan Lake can be posted. The provider can send a new message from message page 408 if the visit is active. After 30 days, messages can no longer be posted and the message page 408 is effectively closed from new messages.

The screen captures shown in FIGS. 9-16 may be part of a web based presentation of the process of the machine-based system 5. The patient 7, provider, and pharmacist 45 may interact and use the process through a series of web based pages presented to the individual on display screens. In other arrangements, instead of web based pages presented to the individual, an avatar interaction may take place. In this regard, an avatar may guide the patient 7 through pre-screen questions such as height, weight, problem conditions, and so forth. The provider and pharmacist 45 may also interact with the avatar to implement the process of the machine-based system 5. The machine-based system 5 may implement voice recognition features so that some or all of the input data by the patient 7, provider, or pharmacist 45 is understood by the various computers and servers 10, 30, 25, 35, 40, 45 with or without the need to have supplemental manual, text entry or output of data.

The various methods and machine based system 5 previously discussed may be carried out by a computer or by a series of computers connected to one another through a network 15 in accordance with certain exemplary embodiments. FIG. 8 illustrates a machine based system 5 constructed and arranged to execute and manage the medical evaluation and record keeping system. Two different user computer systems 10 are illustrated. Either one of, or both, of the user computer systems 10 can be used by the user to implement the machine based system 5. A user computer system 10 includes a user processor 314 that is in communication with a user memory 312, a user display 310, and a user interface card 318. This particular user computer system 10 may be, for example, a PC located in the home of the user. The user processor 314, and other processors described herein, may be a piece of hardware that can execute readable machine instructions for performing various steps and functions. The user processor 314 may include but need not be limited to a microprocessor, a computer server, a digital signal processor, or combinations thereof. The user processor 314 may comprise one or more processors, which may comprise part of a single machine or multiple machines. The user processor 314 is not a signal, but is instead a physical object. The user display 310 may be a piece of hardware. Further, the user display 310 can be a graphical user interface in accordance with certain exemplary embodiments.

The user memory 312 may be solid state memory, random access memory, and/or a database in accordance with different embodiments. The user memory 312 may be a physical object and does not include signals. The user processor 314 and the user memory 312 are not executable applications but instead are hardware that are operable for carrying out instructions. A user printer 316 is also in communication with the user processor 314 and can be used to print out reports or other documents. The user processor 314 can read the user memory 312 and display this information on the user display screen 310. The user printer 316 and the user display screen 310 are pieces of hardware that are located in the machine-based system 5. User interface card 318 can be in communication with a router 344 or other device to allow for communication with a network 15. Network 15 could be a public switched telephone network, the internet, or a local area network in accordance with certain exemplary embodiments.

Another example of the user computer system 10 is shown in FIG. 8 as having the user processor 314, the user memory 312, the user display 310, and the user keyboard 308 and may be a mobile device such as a PDA, cell phone, smart phone, tablet, or sensor-enabled wearable. The user memory 312 may have an application stored thereon that allows him or her to implement the machine-based system 5. The user keyboard 308 can be made of a series of soft-keys on the user display 310 in certain exemplary embodiments. The user can use the user computer system 10 outside of his or her home or office and thus the system 10 may provide mobile functionality.

The provider can access the machine-based system 5 through the use of a provider computer system 332 that has a provider processor 340 in communication with a provider memory 338, a provider display 336, and a provider keyboard 334. The provider computer system 332 can be located at an office of the provider, or may be a mobile device as described previously with reference to the user computer system 10 in other embodiments so that the provider can access the machine-based system 5 from remote locations. The provider processor 340 may be in communication with the network 15 via a router 346 in order to send information to and to receive information from other components of the machine-based system 5.

The payment web server 35 may include a payment processor 324 and a payment memory 326 that are in communication with one another. Although not shown in FIG. 8, other elements such as a display screen, keyboard, interface card, printer, and router could be incorporated into the payment web server 35 in other arrangements. The payment processor 324 is in communication with the network 15 so as to then be in communication with the other components of the machine-based system 5 to send data to and to receive data from the other components.

The pharmacy database web server 40 is incorporated into the machine-based system 5 and includes a pharmacy database memory 320 that is in communication with a pharmacy database processor 322. Again, other hardware as previously discussed may be incorporated. The pharmacy database web server 40 is in communication with the other components of the machine-based system 5 via the network 15 connection to the pharmacy database processor 322. Data such as allergy information, drug interaction information, and drug dosage information may be stored in the pharmacy database memory 320. Although described as being a separate component, the pharmacy database web server 40 may be part of the portal web server 25 and need not be a separate component that needs to be accessed over a public network 15. In this regard, information on the pharmacy data base memory 320 can be included on memory 300 and the owner of the portal web server 25 may also own the information associated with and the pharmacy data base server 40 itself.

Also included in the machine-based system 5 is a pharmacy computer 45. The pharmacy computer 45 is a computer system of a particular pharmacy 45 that allows the pharmacists to view e-prescriptions of particular patients to then subsequently fill those prescriptions. The pharmacy computer 45 includes a pharmacy computer processor 348 in communication with a pharmacy computer memory 350. The pharmacy computer processor 348 is in communication with the other components of the machine-based system 5 through connection with the network 15. As with other servers and computer systems described herein, additional hardware components can be part of the pharmacy computer 45.

The machine-based system 5 also includes the portal web server 25 that has a portal web server processor 302 linked to the network 15 in order to allow the portal web server 25 to be in communication with other components of the machine-based system 5 through the network 15. The portal web server 25 also includes a memory 300 in communication with the processor 302. The portal web server processor 302 and the portal web server memory 300 are pieces of hardware. Although not shown, additional hardware components may be included in the portal web server 25 in other arrangements such as a display, a keyboard, an interface card, or a router. Certain elements of the machine-based system 5 may be located at the portal web server 25. The first image 304 can be stored in the portal web server memory 300. The second image 306, that may be an image different than the first image 304 may be likewise stored in the portal web server memory 300. The second image 306 may be created by the user 7 when the provider determines that the first image 304 created by the user 7 is not sufficient for completing the medical evaluation. The provider can request the second image 306 be created and the second image 306 may be stored in the web portal server memory 300. One or more user records 90 can also be stored on the web portal server memory 300, and may be updated from time to time as the machine-based system 5 is used.

Various elements, such as software and data, can be stored in any one of or multiple ones of the memories 312, 338, 326, 320, 350, 300. The user records 90, drug interaction data, allergy data, drug information, payment information, images 304 and 306, patient waiting room lists, dashboard 180, user demographics, drugs used by the user 7, allergies of the user 7, health conditions of the user 7, and e-prescriptions may be stored on any one of or various ones of the memories 312, 338, 326, 320, 350, 300. The various processors 314, 340, 324, 322, 348, and 302 can access information stored in the memories 312, 338, 326, 320, 350, 300 and can transfer this information to other ones of the processors 314, 340, 324, 322, 348, and 302. Although single processors and memories are disclosed as making up the various computers and servers 10, 332, 354, 40, 45 and 25, in other arrangements multiple processors and memories may be present. Further, multiple computers and servers may make up the various computers and servers 10, 332, 354, 40, 45 and 25 and they need not each be made up of a single computer or server. The various instructions, software, data, and interactions discussed with reference to FIGS. 1-7 can be implemented on the processors and memories 314, 340, 324, 322, 348, 302, 312, 338, 326, 320, 350, 300 discussed in relation to the particular computer or server 10, 332, 354, 40, 45 and 25 that implements the stated instructions, software, data or interactions of the process of the machine-based system 5. The machine-based system 5 may include a physical drug that is obtained by the user 7 at the pharmacy 45 upon completion of the medical evaluation and treatment plan. The drug is only given to the user 7 after the pharmacy 45 has received a proper e-prescription. In some instances the e-prescription may originate from an order from the portal web server 25 through a third party vendor.

Information from the process relating to patient data may be merged with other, outside systems utilized by the provider. In this regard, the provider may have a set of patients that come into the provider's office. The provider may have an outside computer system that coordinates patient data for these patients. Patients 7 evaluated by the provider in virtual space, for example those through the current process, may also have data that the provider seeks to organize and reference. Data from patients 7 seen in a virtual environment may be merged with the physical office practice patients of the provider into the provider's outside computer system so that the provider has access to both virtual and physical patient information in one outside computer system. Alternatively, or additionally, patient information from those that visit the provider's physical office may be uploaded into the machine-based system 5, for example within the web portal web server 25, so that the provider can access the machine-based system 5 to retrieve patient information for both his or her virtual patients and his or her office visit patients.

The machine-based system 5 has been shown and described with reference to a provider that is a dermatologist and a patient 7 that has a skin problem. However, it is to be understood that this is only for sake of example and that dermatology is but one area of medical evaluation that can be implemented with the machine-based system 5. The machine-based system 5 can be used with any area of medicine in which the user can be a patient or can be a representative of a patient. In other arrangements, the machine-based system 5 disclosed herein may be used with medical evaluations that are dermatology evaluations, dental evaluations, urology evaluations, neurology evaluations, veterinary evaluations, forensic evaluations, or podiatry evaluations. It is to be understood that the machine-based system 5 is not limited to dermatology evaluations.

The methods and systems described herein can be executed through instructions contained in non-transitory tangible computer readable storage medium. The various memories 312, 338, 326, 320, 350, 300 previously discussed may be this type of memory. The computer readable medium may be an article of manufacture having the capability to store one or more computer programs, one or more pieces of data, or a combination thereof. The computer readable medium may include a computer memory, hard disk, memory stick, magnetic tape, floppy disk, optical disk (CD or DVD), zip drive, solid-state drive, or combinations thereof. The memories described herein may physically change when data is written to the memories such that there is a physical transformation of the memories upon execution of the article of manufacture. The computer readable medium is not a signal and is not and does not include transitory propagating signals. The computer readable medium is not a modulated data signal such as a carrier wave.

The instructions may cause the various processors 314, 340, 324, 322, 348, and 302 to perform certain steps as discussed. All of the methods and alternate methods can be carried out in a system using instructions on non-transitory computer readable medium executed by one or more processors. The machine-based system and computer readable medium and the article of manufacture, and methods, disclosed herein require and are limited to use in some manner with a computer. The machine-based system and the article of manufacture and the computer readable medium, and methods, disclosed herein do not include transitory embodiments.

The patient 7, care provider, and anyone else using the machine based system 5 may employ any type of interactive interface to retrieve information from the machine based system 5 and to send information to the machine based system 5.

The terms and expressions which have been employed herein are used as terms of description and not as limitation, and there is no intention in the use of such terms and expressions of excluding equivalents of the features shown and described or portions thereof, it being recognized that various modifications are possible within the scope of the invention claimed. Although particular embodiments of the present invention have been illustrated in the foregoing detailed description, it is to be further understood that the present invention is not to be limited to just the embodiments disclosed, but that they are capable of numerous rearrangements, modifications and substitutions.

1. A machine-based system for managing a medical evaluation, comprising:
a memory that has stored a first image taken by a user, wherein a provider views the first image to conduct a medical evaluation; and
a processor communicatively coupled to the memory that sends a request to the user to provide a second image for purposes of further conducting the medical evaluation after viewing of the first image by the provider.

2. The machine-based system as set forth in claim 1, wherein the first image is not sufficient for the provider to complete the medical evaluation, wherein the memory has stored a condition history, wherein the provider views the condition history to conduct the medical evaluation.

3. The machine-based system as set forth in claim 1, wherein the memory and the processor are part of a portal web server of a medical system, and further comprising:
a digital camera used by the user to take the first image and the second image;
a computer system of the user that has a user keyboard, a user display, a user memory, and a user processor;
a network;
a pharmacy web server that has a pharmacy memory and a pharmacy processor in communication with one another, wherein the portal web server sends a query to the pharmacy web server to obtain allergy data and drug interaction information from the pharmacy memory, wherein the provider submits a prescription order to the pharmacy web server.

4. The machine-based system as set forth in claim 3, further comprising a payment server that has a payment processor and a payment memory, wherein the payment processor processes a payment made from the user at a point in time after storage in the memory of the portal web server of the first image, wherein the payment processor processes a payment to the provider at a point in time after submission of the prescription order to the pharmacy web server.

5. The machine-based system as set forth in claim 1, wherein the medical evaluation is selected from the group consisting of a dermatology evaluation, a dental evaluation, a urology evaluation, a neurology evaluation, a veterinary evaluation, a forensic evaluation and a podiatry evaluation.

6. The machine-based system as set forth in claim 1, wherein after viewing the second image the provider cannot complete the medical evaluation and a message is sent to the user to make an office visit.

7. The machine-based system as set forth in claim 1, wherein the processor receives condition information from the user that is used to conduct the medical evaluation, wherein the condition information is stored by the memory.

8. The machine-based system as set forth in claim 1, wherein the processor generates a dashboard for the provider that has a list of patients assigned to the provider for medical treatment.

9. The machine-based system as set forth in claim 1, wherein the processor generates a dashboard for the provider, wherein the processer selects the user from a list of potential patients that have not been assigned to any other provider and are within a licensed territory of the provider, wherein the processor selects the user based upon an amount of time the user has been waiting.

10. A machine-based system for managing a medical evaluation, comprising:
a memory that has stored a first image taken by a user of a medical condition, wherein a provider views the first image to conduct a medical evaluation; and
a processor communicatively coupled to the memory, wherein the memory and the processor are part of a portal web server of a medical system; and
a pharmacy web server that has a pharmacy memory and a pharmacy processor that is communicatively coupled to the pharmacy memory, wherein the portal web server sends a query to the pharmacy web server to obtain allergy data and drug interaction data from the pharmacy memory.

11. The machine-based system as set forth in claim 10, further comprising:
a digital camera used by the user to take the first image;
a computer system of the user that has a user keyboard, a user display, a user memory, and a user processor; and
a network, wherein the query from the portal web server to the pharmacy web server to obtain allergy data and drug interaction data from the pharmacy memory is transferred through the network, and wherein results of the query are stored in a user record in the memory of the portal web server;
wherein the memory has stored a condition history.

12. The machine-based system as set forth in claim 10, wherein the processor of the portal web server sends a first query to the pharmacy web server to verify a selected pharmacy of the user, wherein the user updates pharmacy information in a user record in the memory of the portal web server if the selected pharmacy of the user is not valid, wherein the processor of the portal web server sends a second query to the pharmacy web server to verify the updated pharmacy information of the user.

13. The machine-based system as set forth in claim 10, further comprising:
a computer system of the provider that has a provider keyboard, a provider display, a provider memory, and a provider processor, wherein the provider processor sends a query to the memory of the portal web server to access a user record of the memory of the portal web server to determine if a prescription desired by the provider in view of the medical evaluation is an appropriate prescription and not a duplication.

14. The machine-based system as set forth in claim 10, wherein the provider prescribes a prescription to the user such that a prescription query is sent to the pharmacy web server for use in selecting an appropriate prescription, wherein the processor of the portal web server provides a dosage calculator to the provider for use in selecting an appropriate topical prescription volume prescription by the provider, wherein a user record of the memory of the portal web server is updated after prescription generation by the provider; and
further comprising a drug that is given to the user after generation of the prescription.

15. The machine-based system as set forth in claim 10, wherein the processor of the portal web server sends a request to the user to provide a second image for purposes of further conducting the medical evaluation after viewing of the first image by the provider, wherein the second image is stored in the memory of the portal web server after provision by the user; and further comprising:
a payment server that has a payment processor and a payment memory that is communicatively coupled to the payment processor, wherein the payment processor processes a payment made from the user at a point in time after storage in the memory of the portal web server of the first image, wherein the payment processor processes a payment to the provider at a point in time after completion of the medical evaluation.

16. A machine-based system for managing a medical evaluation, comprising:
a memory that has stored a first image taken by a user of a medical condition, wherein a provider views the first image to conduct a medical evaluation; and
a processor communicatively coupled to the memory, wherein the memory and the processor are part of a portal web server of a medical system; and
a payment web server that has a payment memory and a payment processor that is communicatively coupled to the payment memory, wherein the payment processor processes a payment made from the user at a point in time after storage in the memory of the portal web server of the first image, wherein if the medical evaluation is completed by the provider the payment processor processes a payment to the provider, and wherein if the medical evaluation is not completed by the provider the payment processor processes a refund of the payment made from the user back to the user;
wherein the processor of the portal web server sends a request to order a prescription for the user.

17. The machine-based system as set forth in claim 16, wherein the processor of the portal web server sends a request to the processor of the payment web server to execute the payment by the user, wherein a user record located in the memory of the portal web server is updated after processing of the payment by the user by the processor of the payment web server, wherein the memory has stored a condition history.

18. The machine-based system as set forth in claim 16, wherein the processor of the web based portal sends a request to the user to provide a second image for purposes of further conducting the medical evaluation after viewing of the first image by the provider, wherein the first image is not sufficient for the provider to complete the medical evaluation, wherein the user takes the second image and the second image is stored in the memory of the web based portal.

19. A machine-based system as set forth in claim 16, further comprising a pharmacy web server that has a pharmacy memory and a pharmacy processor that is communicatively coupled to the pharmacy memory, wherein the portal web server sends a query to the pharmacy web server to obtain allergy data and drug interaction data from the pharmacy memory, wherein the provider prescribes the prescription to the user such that a prescription query is sent to the pharmacy web server for use in selecting an appropriate prescription, wherein the payment web server processes the payment to the provider at a point in time after completion of the provision of the prescription by the provider.

20. The machine-based system as set forth in claim 16, wherein the medical evaluation is selected from the group consisting of a dermatology evaluation, a dental evaluation, a urology evaluation, a neurology evaluation, a veterinary evaluation, a forensic evaluation and a podiatry evaluation.
